(19) United States
(12) Patent Application Publication
(10) Pub. No.: US 2012/0300078 A1
(43) Pub. Date: Nov. 29, 2012

(54) ENVIRONMENT RECOGNIZING DEVICE FOR VEHICLE

(75) Inventors: Takehito Ogata, Hitachi (JP); Hiroshi Sakamoto, Hitachi (JP)

(73) Assignee: HITACHI, LTD

(21) Appl. No.: 13/575,480

(22) PCT Filed: Jan. 17, 2011
(86) PCT No.: PCT/JP2011/050643

§ 371 Date: Jul. 26, 2012

(30) Foreign Application Priority Data
Jan. 28, 2010 (JP) 2010-016154

(51) Int. Cl. H04N 7/18

(52) U.S. Cl. 348/148; 348/E07.085

(57) ABSTRACT

There is provided an environment recognizing device for a vehicle capable of reducing false detections for an artificial object such as a utility pole, a guardrail and road paintings with smaller processing load, at the time of detecting a pedestrian by using a pattern matching method. The environment recognizing device for a vehicle includes an image acquisition unit (1011) for acquiring a picked up image in front of an own vehicle; a processing region setting unit (1021) for setting a processing region used for detecting a pedestrian from the image; a pedestrian candidate setting unit (1031) for setting a pedestrian candidate region used for determining an existence of the pedestrian from the image; and a pedestrian determination unit (1041) for determining whether the pedestrian candidate region is the pedestrian or an artificial object depending on a gray-scale variation rate in a predetermined direction within the pedestrian candidate region.

### TECHNICAL FIELD

The present invention relates to an environment recognizing device for a vehicle for detecting a pedestrian based on information picked up by an image pickup device such as an on-board camera.

### BACKGROUND ART

Predictive safety systems for preventing a traffic accident have been developed in order to reduce the number of deaths and injuries due to traffic accidents. In Japan, pedestrian fatal accidents occupy approximately 30% of the entire traffic fatalities, and a predictive safety system for detecting a pedestrian in front of an own vehicle is effective in order to reduce such pedestrian fatal accidents.

A predictive safety system is activated in a situation where there is high possibility of an accident occurrence; and for example, a pre-crash safety system or the like has been practicalized, which prompts a driver's notice by activating an alarm if there occurs a possibility of collision with an obstacle in front of an own vehicle, or activates an automatic brake if collision cannot be avoided, so as to reduce damage on passengers.

As a method of detecting a pedestrian in front of an own vehicle, a pattern matching method is used, which picks up an image in front of an own vehicle by means of a camera, and detects a pedestrian in the picked-up image by using shape patterns of a pedestrian. There are variety of detecting methods using pattern matching, and a false detection of mistaking an object other than a pedestrian for a pedestrian and a non-detection that detects no pedestrian are in a trade-off relation.

Accordingly, to detect a pedestrian in various appearances in an image causes increase in false detections. Such a system that activates an alarm or an automatic brake at a location where no pedestrian exists due to a false detection irritates a driver, resulting in deterioration of reliability on the system.

In particular, if an automatic brake is activated relative to an object (non-3D object) having no possibility to collide with an own vehicle, this even puts the own vehicle in danger, and deteriorates safety performance of the system.

In order to reduce the above mentioned false detections, Patent Document 1 describes a method of performing a pattern matching operation continuously during plural process cycles, thereby detecting a pedestrian based on the cyclic patterns.

Patent Document 2 describes a method of detecting a human head using a pattern matching method and detecting a human body using another pattern matching method, thereby detecting a pedestrian.

### Patent Document 1

JP Patent Publication (Kokai) No. 2009-042941A

### Patent Document 2

JP Patent Publication (Kokai) No. 2008-181423A

### DISCLOSURE OF THE INVENTION

### Problems to be Solved by the Invention

However, the above mentioned methods take no account of a trade-off relation with time. In particular, in the pedestrian detection, it is crucial to execute an initial capture of a pedestrian as quickly as possible after the pedestrian runs out in front of an own vehicle until the pedestrian is detected.

In the method described in Patent Document 1, an image is picked up plural times and the pattern matching is performed on every image; consequently detection becomes delayed to start. The method described in Patent Document 2 requires a dedicated process for every pattern matching method of plural types, which requires large storage capacity and greater processing load for a single pattern matching operation.

On a public road, objects likely to be false detected as a pedestrian by using a pattern matching method often include artificial objects such as a utility pole, a guardrail and road paintings. Hence, to reduce false detections for these objects enhances safety of the system as well as driver's reliability.

The present invention has been made in the light of the above mentioned facts, and has an object to provide an environment recognizing device for a vehicle capable of coping with both processing speed enhancement and false detection reduction.

### Means for Solving the Problems

The present invention includes an image acquisition unit for acquiring a picked up image in front of an own vehicle; a processing region setting unit for setting a processing region used for detecting a pedestrian from the image; a pedestrian candidate setting unit for setting a pedestrian candidate region used for determining an existence of the pedestrian from the image; and a pedestrian determination unit for determining whether the pedestrian candidate region is the pedestrian or an artificial object depending on a gray-scale variation rate in a predetermined direction within the pedestrian candidate region.

### Advantages of the Invention

According to the present invention, it is possible to provide an environment recognizing device for a vehicle capable of coping with both processing speed enhancement and false detection reduction.

### BRIEF DESCRIPTION OF THE DRAWINGS

FIG. 1 is a block diagram of illustrating a first embodiment of an environment recognizing device for a vehicle according to the present invention.

FIG. 2 is a schematic diagram of illustrating images and parameters of the present invention.

FIG. 3 is a schematic diagram of illustrating one example of a process by a processing region setting unit of the present invention.

FIG. 4 is a flow chart of illustrating one example of a process by a pedestrian candidate setting unit of the present invention.

FIG. 5 is a drawing of illustrating weighs of a Sobel filter used at the pedestrian candidate setting unit of the present invention.

FIG. 6 is a drawing of illustrating a local edge determination unit of the pedestrian candidate setting unit of the present invention.

FIG. 7 is a block diagram of illustrating a determination method of determining the pedestrian using an identifier of the pedestrian candidate setting unit of the present invention.

FIG. 8 is a flow chart of illustrating one example of the process by the pedestrian determination unit of the present invention.

FIG. 9 is a drawing of illustrating weights of directional gray-scale variation calculation filters used at the pedestrian determination unit of the present invention.

FIG. 10 is a drawing of illustrating one example of gray-scale variation rates in the vertical and horizontal directions used at the pedestrian determination unit of the present invention.

FIG. 11 is a flow chart of illustrating one example of how to operate a first collision determination unit of the present invention.

FIG. 12 is a drawing of illustrating how to calculate a degree of collision danger on the first collision determination unit of the present invention.

FIG. 13 is a flow chart of illustrating one example of how to operate a second collision determination unit of the present invention.

FIG. 14 is a block diagram of illustrating another embodiment of the environment recognizing device for a vehicle according to the present invention.

FIG. 15 is a block diagram of illustrating a second embodiment of the environment recognizing device for a vehicle according to the present invention.

FIG. 16 is a block diagram of illustrating a third embodiment of the environment recognizing device for a vehicle according to the present invention.

FIG. 17 is a flow chart of illustrating how to operate a second pedestrian determination unit of the third embodiment of the present invention.

### DESCRIPTION OF SYMBOLS

1000 Environment recognizing device for a vehicle
1011 Image acquisition unit
1021 Processing region setting unit
1031 Pedestrian candidate setting unit
1041 Pedestrian determination unit
1111 Object position detection unit
1211 First collision determination unit
1221 Second collision determination unit
1231 Collision determination unit
2000 Environment recognizing device for a vehicle
2031 Pedestrian candidate setting unit
2041 Pedestrian determination unit
2051 Pedestrian decision unit
3000 Environment recognizing device for a vehicle
3041 First pedestrian determination unit
3051 Second pedestrian determination unit

### BEST MODE FOR CARRYING OUT THE INVENTION

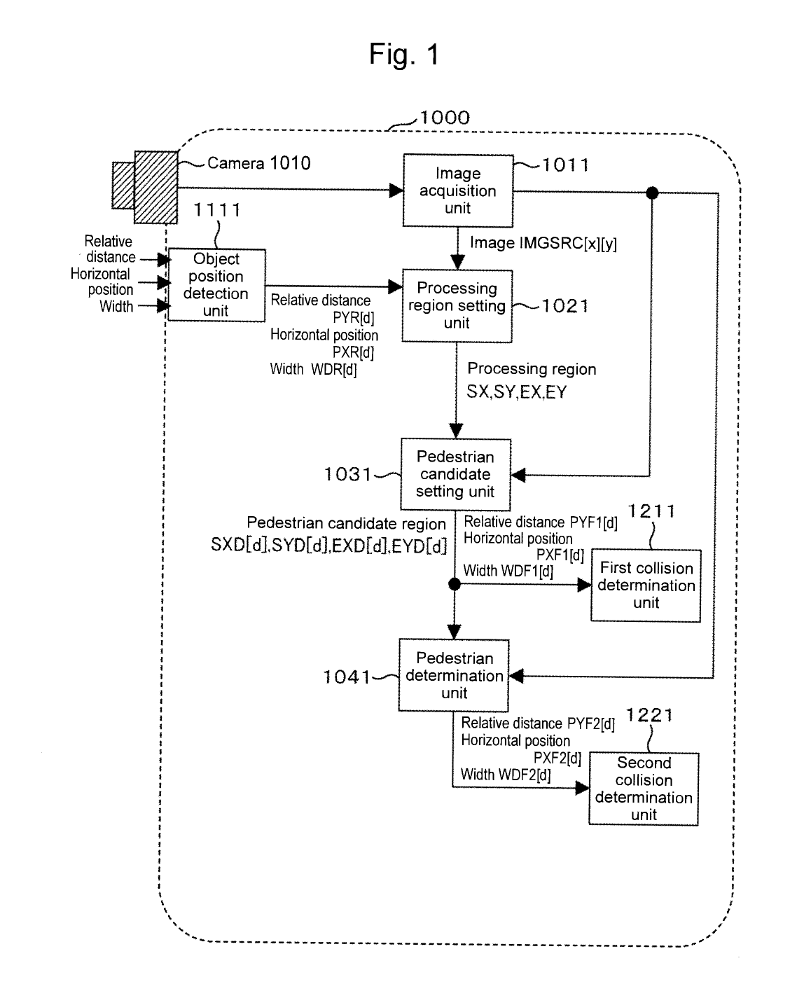

Hereinafter, detailed descriptions will be provided on the first embodiment of the present invention with reference to the drawings. FIG. 1 is a block diagram of an environment recognizing device for a vehicle 1000 according to the first embodiment.

The environment recognizing device for a vehicle 1000 is configured to be embedded in a camera 1010 mounted on the vehicle or in an integrated controller or the like, and to detect preset objects from an image picked up by the camera 1010, and in the present embodiment, is configured to detect a pedestrian from a picked up image in front of the own vehicle.

The environment recognizing device for a vehicle 1000 includes a computer having a CPU, memories, I/O and other components, in which predetermined processes are programmed so as to be repetitively executed in predetermined cycles. As illustrated in FIG. 1, the environment recognizing device for a vehicle 1000 includes an image acquisition unit 1011, a processing region setting unit 1021, a pedestrian candidate setting unit 1031 and a pedestrian determination unit 1041, and in other embodiments, further includes an object position detection unit 1111, a first collision determination unit 1211 and a second collision determination unit 1221.

The image acquisition unit 1011 captures data picked up in front of the own vehicle from the camera 1010 that is so mounted at a location where the camera can pick up an image in front of the own vehicle, and write the image data as an image IMGSRC[x][y] on the RAM that is a storage device. The Image IMGSRC[x][y] is a 2D array, and x and y represent coordinates of the image, respectively.

The processing region setting unit 1021 sets a region (SX, SY, EX, EY) used for detecting a pedestrian in the image IMGSRC[x][y]. The detailed descriptions of the process will be provided later.

The pedestrian candidate setting unit 1031 first calculates a gray-scale gradient value from the image IMGSRC[x][y], and generates a binary edge image EDGE[x][y] and a gradient direction image DIRC[x][y] having information regarding the edge direction. Then, the pedestrian candidate setting unit 1031 sets the matching determination regions (SXG[g], SYG[g], EXG[g], EYG[g]) used for determining the pedestrian in the edge image EDGE[x][y], and uses the edge image EDGE[x][y] in each matching determination region and the gradient direction image DIRC[x][y] in this region at the corresponding position, so as to recognize the pedestrian. Where, the g denotes an ID number if plural regions are set. The recognizing process will be described in detail later. Among the matching determination regions, the region recognized to be a pedestrian is used in the following process as the pedestrian candidate region (SXD[d], SYD[d], EXD[d], EYD[d]) and as the pedestrian candidate object information (relative distance PYF1[d], horizontal position PXF1[d], horizontal width WDF1[d]). The d denotes an ID number if plural objects are set.

The pedestrian determination unit 1041 first calculates four kinds of gray-scale variations in the 0 degree direction, the 45 degree direction, the 90 degree direction and the 135 degree direction from the image IMGSRC[x][y], and generates the directional gray-scale variation images (GRAD000[x][y], GRAD045[x][y], GRAD090[x][y], GRAD135[x][y]). Next, the pedestrian determination unit 1041 calculates the gray-scale variation rate in the vertical direction RATE_V and the gray-scale variation rate in the horizontal direction RATE_H based on the directional gray-scale variation images (GRAD000[x][y], GRAD045[x][y], GRAD090[x][y], GRAD135[x][y]) in the pedestrian candidate regions (SXD[d], SYD[d], EXD[d], EYD[d]), and determines that the pedestrian candidate region of interest is the pedestrian if both the rate values are smaller than the threshold values cTH_RATE_V and cTH_V_RATE_H, respectively. If the pedestrian candidate region of interest is determined to be the pedestrian, this is stored as the pedestrian object information (relative distance PYF2[p], horizontal position PXF2[p], horizontal width WDF2[p]). Details of the determination will be described later.

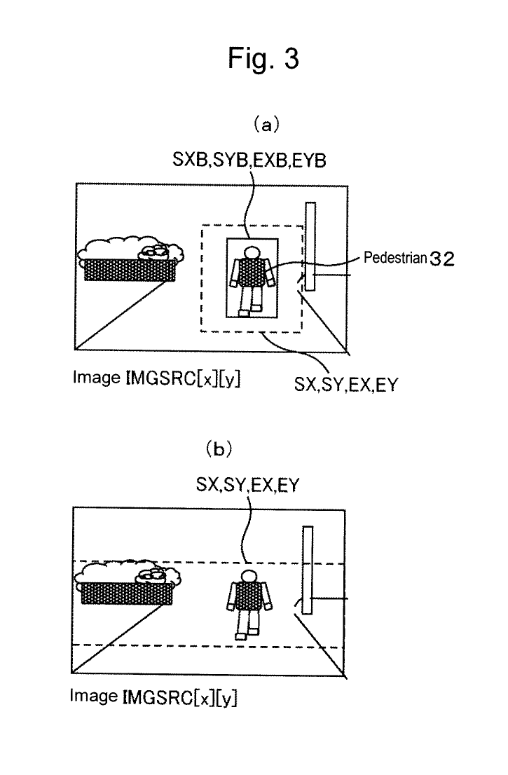

The object position detection unit 1111 acquires a detection signal from a radar such as a millimeter wave radar or a laser radar mounted on the own vehicle, which detects an object in the vicinity of the own vehicle, so as to detect the position of an object existing in front of the own vehicle. For example, as illustrated in FIG. 3, the object position (relative distance PYR[b], horizontal position PXR[b], horizontal width WDR[b]) of an object such as a pedestrian 32 in the vicinity of the own vehicle is acquired from the radar. The b denotes an ID number if plural objects are detected. The information regarding the above object position may be acquired by inputting a signal from the radar directly into the environment recognizing device for a vehicle 1000, or may be acquired through communication using the radar and the LAN (Local Area Network). The object position detected at the object position detection unit 1111 is used at the processing region setting unit 1021.

The first collision determination unit 1211 calculates a degree of collision danger depending on the pedestrian candidate object information (relative distance PYF1[d], horizontal position PXF1[d], horizontal width WDF1[d]) detected at the pedestrian candidate setting unit 1031, and determines whether or not alarming or braking is necessary in accordance with the degree of collision danger. Details of the process will be described later.

The second collision determination unit 1221 calculates a degree of collision danger depending on the pedestrian object information (relative distance PYF2[p], horizontal position PXF2[p], horizontal width WDF2[p]) detected at the pedestrian determination unit 1041, and determines whether or not alarming or braking is necessary in accordance with the degree of collision danger. Details of process will be described later.

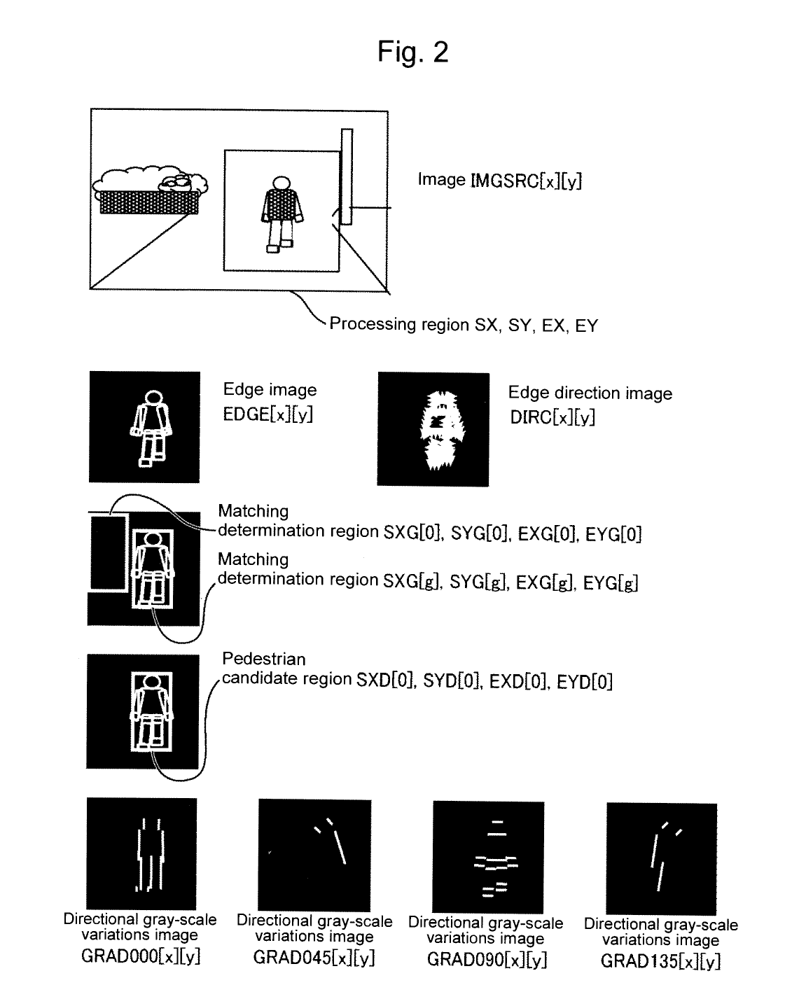

FIG. 2 illustrates an example of the images and the regions used in the above descriptions. As illustrated in the drawing, the processing region SX, SY, EX, EY is set in the image IMGSRC[x][y] at the processing region setting unit 1021, and the edge image EDGE[x][y] and the gradient direction image DIRC[x][y] are generated at the pedestrian candidate setting unit 1031 from the image IMGSRC[x][y]. At the pedestrian determination unit 1041, the directional gray-scale variation images (GRAD000[x][y], GRAD045[x][y], GRAD090[x][y], GRAD135[x][y]) are generated from the image IMGSRC[x][y]. Each matching determination region (SXG[g], SYG[g], EXG[g], EYG[g]) is set in the edge image EDGE[x][y] and the gradient direction image DIRC[x][y], and the pedestrian candidate region (SXD[d], SYD[d], EXD[d], EYD[d]) is a region recognized as the pedestrian candidate among the matching determination regions at the pedestrian candidate setting unit 1031.

Next, with reference to FIG. 3, descriptions will be provided on the process of the processing region setting unit 1021. FIG. 3 illustrates an example of the process of the processing region setting unit 1021.

The processing region setting unit 1021 selects a region used for performing the pedestrian detection process in the image IMGSRC[x][y], and finds the range of the coordinates of the selected region, the start point SX and the end point EX of the x coordinates (horizontal direction), and the start point SY and the end point EY of the y coordinates (vertical direction).

The processing region setting unit 1021 may use or may not use the object position detection unit 1111. Descriptions will now be provided on the case of using the object position detection unit 1111.

FIG. 3(a) illustrates an example of the process of the processing region setting unit 1021 in the case of using the object position detection unit 1111.

Based on the relative distance PYR[b], the horizontal position PYR[b] and the horizontal width WDR[b] of the object detected by the object position detection unit 1111, the position in the image (start point SXB and end point EXB of x coordinates (horizontal direction); and start point SYB and end point EYB of the y coordinates (vertical direction)) of the detected object is calculated. The camera geometric parameters for associating the coordinates on the camera image with the positional relation in reality are calculated in advance using a camera calibration method or the like, and it is assumed in advance that an object has a height of 180 [cm], for example, so as to uniquely define the position of the object in the image.

A difference may occur between the position in the image of an object detected at the object position detection unit 1111 and the position in the image of the same object captured in the camera image due to a mounting error of the camera 1010, communication delay with the radar, or the like. For this reason, the object position (SX, EX, SY, EY) is calculated by correcting the object position (SXB, EXB, SYB, EYB) in the image. This correction is carried out by magnifying or moving the region to the predetermined extent. For example, in this correction, SXB, EXB, SYB, EYB are expanded horizontally and or vertically by the predetermined pixels. In this way, the processing region (SX, EX, SY, EY) can be obtained.

If there are plural regions to be processed, each processing region (SX, EX, SY, EY) is generated individually, and the following process is performed for each processing region individually.

Descriptions will now be provided on the process of setting the processing region (SX, EX, SY, EY) executed by the processing region setting unit 1021 without using the object position detection unit 1111.

An example of the region setting method without using the object position detection unit 1111 may include a method of setting plural regions having different sizes so as to inspect the entire image, and a method of setting a region at a particular position or in a particular size. In the method of setting a region at a particular position, the region is limitedly set to a position where the own vehicle travels in T seconds using the own vehicle speed, for example.

FIG. 3(b) illustrates an example of finding a position where the own vehicle travels in two seconds, using the own vehicle speed. The position and size of the processing region are determined by finding the range in the y direction (SYP, EYP) in the image IMGSRC[x][y] using the camera geometric parameter based on the road height (0 cm) in the relative distance to the position where the own vehicle travels in 2 seconds, and the assumed height of the pedestrian (180 cm in the present embodiment). The range in the x direction (SXP, EXP) may unnecessary be limited, or may be limited by using the predicted traveling rout of the own vehicle, for example. In this way, the processing region (SX, EX, SY, EY) can be obtained.

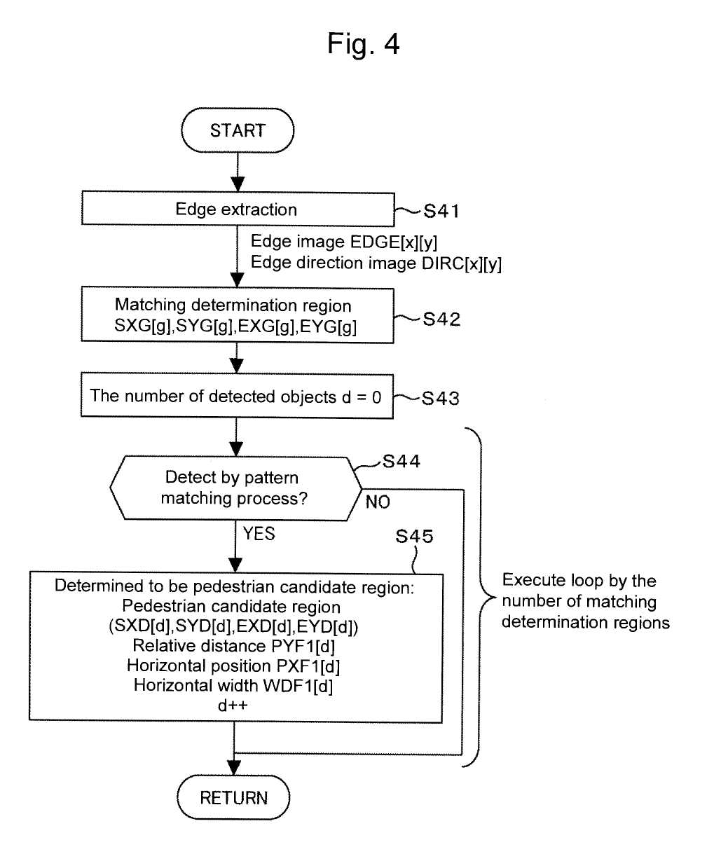

Descriptions will now be provided on the process by the pedestrian candidate setting unit 1031. FIG. 4 is a flow chart of the process by the pedestrian candidate setting unit 1031.

In Step S41, edges are first extracted from the image IMGSRC[x][y]. Descriptions will be provided on the method of calculating the edge image EDGE[x][y] and the gradient direction image DIRC[x][y] using the Sobel filter as the differential filter, as follows.

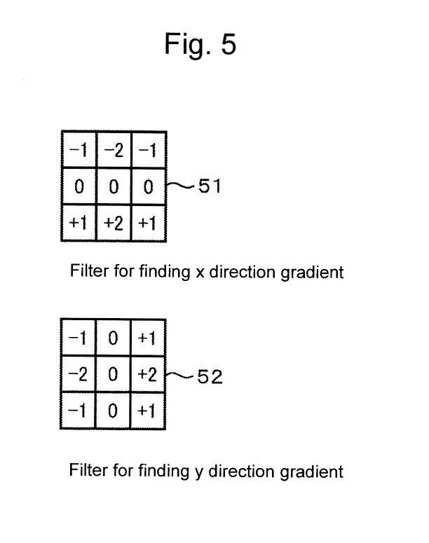

The Sobel filter has a size of 3×3 as illustrated in FIG. 5, and has two kinds of filters: an x direction filter 51 for finding the gradient in the x direction and a y direction filter 52 for finding the gradient in the y direction. In order to find the gradient in the x direction from the image IMGSRC[x][y], the following calculation is executed for every pixel in the image IMGSRC[x][y]: the pixel values of nine pixels in total consisting of one pixel of interest and its neighboring eight pixels are subjected to a product sum operation with the respective weights of the x direction filter 51 at the corresponding positions. The result of the product-sum operation is the gradient in the x direction for the pixel of interest. The same calculation is executed for finding the gradient in the y direction. If the calculation result of the gradient in the x direction at a certain position (x, y) in the image IMGSRC[x][y] is expressed as dx, and the calculation result of the gradient in the y direction at the certain position (x, y) in the image IMGSRC[x][y] is expressed as dy, the gradient magnitude image DMAG[x][y] and the gradient direction image DIRC[x][y] are calculated by the following formulas (1) and (2).

(Formula 1)

DMAG[x][y]=|dx|+|dy| (1)

(Formula 2)

DIRC[x][y]=arctan(dy/dx) (2)

Each of the DMAG[x][y] and the DIRC[x][y] is a 2D array having the same size as the image IMGSRC[x][y], and the coordinates (x, y) of the DMAG[x][y] and the DIRC[x][y] correspond to the coordinates (x, y) of the IMGSRC[x][y].

Each calculated value of the DMAG[x][y] is compared to the edge threshold value THR_EDGE, and if the comparison result is DMAG[x][y]>THR_EDGE, the value of 1 is stored; if not, the value of 0 is stored in the edge image EDGE[x][y].

The edge image EDGE[x][y] is a 2D array having the same size as the image IMGSRC[x][y], and the coordinates (x, y) of the EDGE[x][y] correspond to the coordinates (x, y) of the image IMGSRC[x][y].

Before the edge extraction, the image IMGSRC[x][y] may be cut out, and the object in the image may be magnified or demagnified in the predetermined size. In the present embodiment, the above described edge calculation is performed by magnifying or demagnifying the image so as to set every object in the image IMGSRC[x][y] having the height of 180 [cm] and the width of 60 [cm] in the size of 16 dots×12 dots based on the distance information and the camera geometric used at the processing region setting unit 1021.

The calculations of the edge image EDGE[x][y] and the gradient direction image DIRC[x][y] are executed limitedly within the range of the processing region (SX, EX, SY, EY), and values for the other portions out of this range may all be set to 0.

In Step S42, the matching determination regions (SXG[g], SYG[g], EXG[g], EYG[g]) for determining a pedestrian are set in the edge image EDGE[x][y]. As described in Step S41, the present embodiment uses the camera geometry to generate the edge image by magnifying or demagnifying the image so as to set every object in the image IMGSRC[x][y] having the height of 180 [cm] and the width of 60 [cm] in the size of 16 dots×12 dots.

Therefore, the matching determination region is set in the size of 16 dots×12 dots, and if the edge image EDGE[x][y] is larger than the size of 16 dots×12 dots, the plural matching determination regions are arranged at a constant interval so as to cover the edge image EDGE[x] [y].

In Step S43, the number of the detected objects d is set to d=0, and the following process is executed for every matching determination region.

In Step S44, the matching determination region (SXG[g], SYG[g], EXG[g], EYG[g]) of interest is first determined using an identifier 71 described in detail later. If the identifier 71 determines that the matching determination region is the pedestrian, the process shifts to Step S45, where the position of this region in the image is set to be the pedestrian candidate region (SXD[d], SYD[d], EXD[d], EYD[d]), and the pedestrian candidate object information (relative distance PYF1[d], horizontal position PXF1[d], horizontal width WDF1[d]) is calculated, and the d is incremented.

The pedestrian candidate object information (relative distance PYF1[d], horizontal position PXF1[d], horizontal width WDF1[d]) is calculated by using the detected position in the image and the camera geometry model. If the object position detection unit 1111 is available, the value of the relative distance PYR[b] that can be obtained from the object position detection unit 1111 may be used instead of using the relative distance PYF1[d].

Next, descriptions will be provided on the method of determining whether or not the matching determination region is the pedestrian, using the identifier 71.

Examples of a method of detecting the pedestrian by means of the image processing includes a template matching method in which plural templates representing the pedestrian patterns are prepared in advance, and the cumulative differential calculation or the normalized correlation calculation is executed so as to find the coincidence degree in the matching; and a pattern recognition method using an identifier such as the neural network.

Any of the above methods requires in advance database of sources serving as indexes for the pedestrian determination. Various patterns of the pedestrian are stored as the database, and representative templates and or the identifier are generated based on the database. In the real environment, various pedestrians in various cloths, postures and body figures exist, and in addition, there is variety of different illumination conditions and or whether conditions, which requires large amount of database so as to reduce false determination.

In such a case, the former template matching method is not practical because of tremendous numbers of templates required for preventing detection omissions. Hence, the present embodiment employs the latter method of determining the pedestrian using the identifier. The capacity of the identifier is not dependent on the scale of the source database. The database for generating the identifier is referred to as the supervised data.

The identifier 71 used in the present embodiment determines whether to be the pedestrian or not based on the plural local edge determination units.

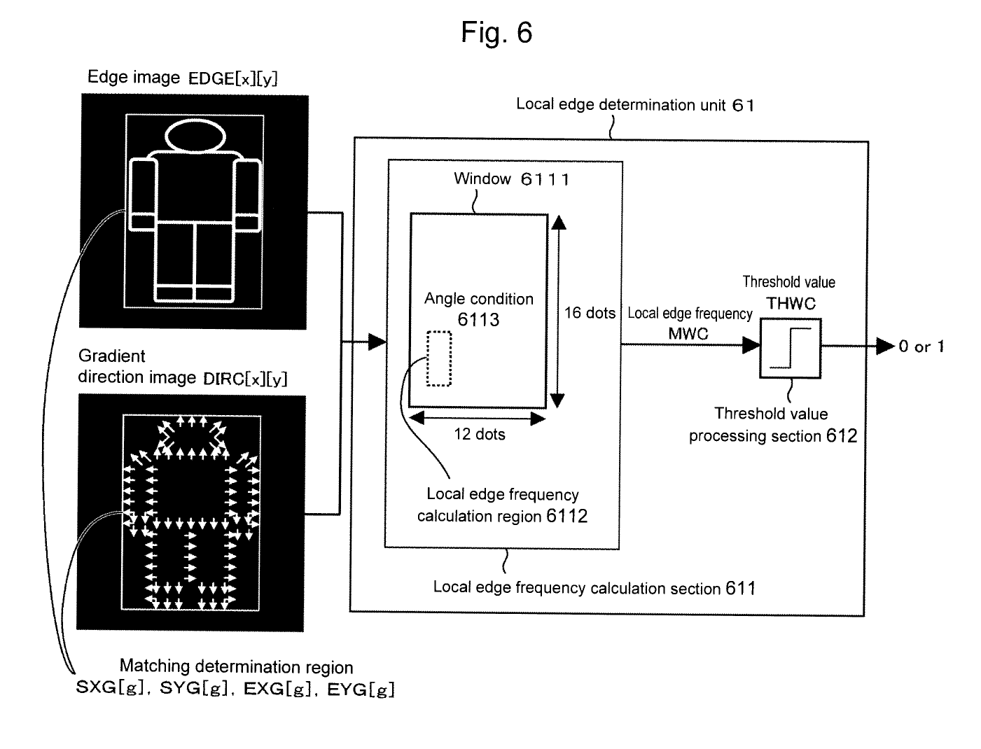

The local edge determination unit will now be described with reference to the example of FIG. 6. A local edge determination unit 61 inputs the edge image EDGE[x][y], the gradient direction image DIRC[x][y], and the matching determination regions (SXG[g], SYG[g], EXG[g], EYG[g]), and outputs a binary value of 0 or 1, and includes a local edge frequency calculation section 611 and a threshold value processing section 612.

The local edge frequency calculation section 611 holds a local edge frequency calculation region 6112 in a window 6111 having the same size as the matching determination region (SXG[g], SYG[g], EXG[g], EYG[g]) of interest, and sets positions used for calculating the local edge frequency in the edge image EDGE [x][y] and in the gradient direction image DIRC[x][y] based on the positional relation between the matching determination region (SXG[g], SYG[g], EXG[g], EYG[g]) of interest and the window 6111, so as to calculate the local edge frequency MWC.

The local edge frequency MWC represents the total number of pixels included in the gradient direction image DIRC[x][y] whose angle value satisfies an angle condition 6113 and in the edge image EDGE [x][y] at the corresponding position having the value of 1.

In the example of FIG. 5, the angle condition 6113 is to satisfy that the angle value is between 67.5 degrees and 112.5 degrees or between 267.5 degrees and 292.5 degrees, and is used for determining whether or not the value of the gradient direction image DIRC[x][y] stays in a certain range.

The threshold value processing section 612 holds the predefined threshold value THWC#, and outputs the value of 1 if the local edge frequency MWC calculated at the local edge frequency calculation section 611 is equal to or more than the threshold value THWC#; if not, outputs the value of 0. The threshold value processing section 612 may be configured to output the value of 1 if the local edge frequency MWC calculated at the local edge frequency calculation section 611 is equal to or less than the threshold value THWC#; if not, to output the value of 0.

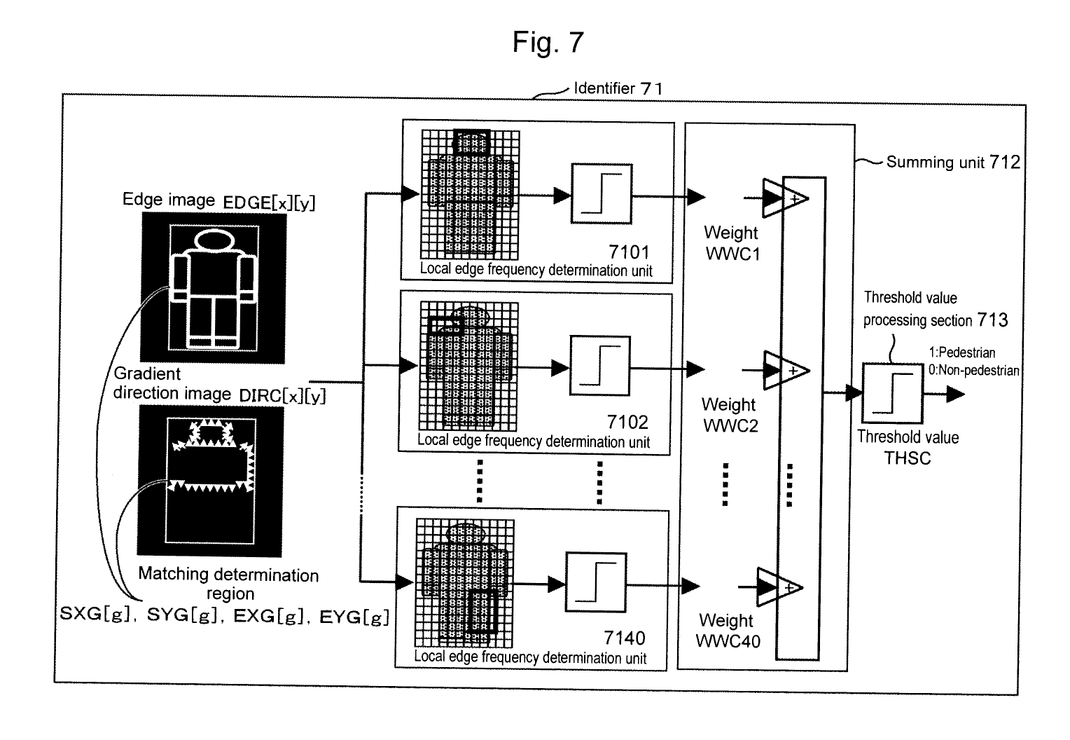

The identifier will now be described with reference to FIG. 7.

The identifier 71 inputs the edge image EDGE[x][y], the gradient direction image DIRC[x][y] and the matching determination regions (SXG[g], SYG[g], EXG[g], EYG[g]), and outputs the value of 1 if the region is determined to be pedestrian; if not, outputs the value of 0. The identifier 71 includes forty local edge frequency determination units 7101 to 7140, a summing unit 712 and a threshold value processing section 713.

Each of the local edge frequency determination units 7101 to 7140 has the same processing function as that of the local edge determination unit 61 as described above, but has the local edge frequency calculation region 6112, the angle condition 6113 and the threshold value THWC#, which are different from those of the local edge determination unit 61, respectively.

The summing unit 712 multiples the output values from the local edge frequency determination units 7101 to 7140 by the corresponding weights WWC1# to WWC40#, and then outputs the sum of these values.

The threshold value processing section 713 holds the threshold value THSC#, and outputs the value of 1 if the output value from the summing unit 712 is greater than the threshold value THSC#; if not, outputs the value of 0.

The local edge frequency calculation region 6112, the angle condition 6113, the threshold value THWC, the weights WWC1# to WWC40# and the final threshold value THSC#, which are parameters for the local edge frequency determination unit of the identifier 71, are adjusted by using the supervised data so as to output the value of 1 if the input image into the identifier is the pedestrian; if not, to output the value of 0. This adjustment may be performed by means of machine learning such as AdaBoost or may be performed manually.

The procedure of determining the parameters using AdaBoost based on, for example, NPD of the supervised data regarding the pedestrian and NBG of the supervised data regarding the non-pedestrian is as follows. Hereinafter, the local edge frequency determination unit is referred to as cWC[m]. Where, m denotes the ID number of the local edge frequency determination unit.

Plural (for example, 1,000,000 patterns of) local edge frequency determination units cWC[m] having the different local edge frequency calculation regions 6112 and the different angle conditions 6113 are prepared, and the value of the local edge frequency MWC is calculated for every local edge frequency determination unit cWC[m] based on all the supervised data, so as to determine the threshold value THWC for every unit. The threshold value THWC is so selected as to optimally classify the supervised data regarding the pedestrian and the supervised data regarding the non-pedestrian.

Every of the supervised data regarding the pedestrian is then weighted with wPD[nPD]=½ NPD. Similarly, every of the supervised data regarding the non-pedestrian is weighted with wBG[nBG]=½ NBG. Where, nPD denotes the ID number of the supervised data regarding the pedestrian, and nBG denotes the ID number of the supervised data regarding the non-pedestrian.

The following process is repetitively performed, where k=1.

The weights are first normalized such that the total weights of the supervised data of all the pedestrian and non-pedestrian becomes 1. Next, the false detection rate cER[m] of each local edge frequency determination unit is calculated. In the local edge frequency determination unit cWC[m] of interest, the false detection rate cER[m] is the total weights of the supervised data regarding the pedestrian whose output values is 0 if these supervised data regarding the pedestrian are input into the local edge frequency determination unit cWC[m], or of the supervised data regarding the non-pedestrian whose output values is 1 if these supervised data regarding the non-pedestrian are input into the local edge frequency determination unit cWC[m], that is, the total of the weights of the supervised data whose output values from the local edge frequency determination unit cWC[m] are wrong.

After the false detection rate cER[m] is calculated for every local edge frequency determination unit, the ID number of the local edge frequency determination unit having the minimum false detection rate mMin is selected, so as to set the final local edge frequency determination unit WC[k] to WC[k]=cWC[mMin].

Next, the weight for each of the supervised data is updated. The update is carried out such that the weights of the supervised data regarding the pedestrian providing the result value of 1 if the final local edge frequency determination unit WC[k] is applied, as well as the supervised data regarding non-pedestrian providing the result value of 0 if the final local edge frequency determination unit WC[k] is applied, that is, the weights of the supervised data providing correct outputs are multiplied by the coefficient BT[k]=cER[mMin]/(1−cER[mMin]).

The process is repetitively executed until the k reaches the predetermined value (40, for example), where k=k+1. The final local edge frequency determination unit WC resulted from the completion of the repetitive process becomes the identifier 71 automatically adjusted by the AdaBoost. Each of the weights WWC1 to WWC40 is calculated based on 1/BT[k], and the threshold value THSC is set to 0.5.

As described above, the pedestrian candidate setting unit 1031 extracts the edges of the outline of the pedestrian, and detects the pedestrian by using the identifier 71.

The identifier 71 used for detecting the pedestrian is not limited to the method described in the present embodiment. Template matching, a neural network identifier, a support vector machine identifier, a Bayesian classifier, or the like, which utilize the normalized correlation, may be used as the identifier 71, instead.

At the pedestrian candidate setting unit, a gray-scale image or a colored image may be directly used and determined by using the identifier 71 without extracting the edges.

The identifier 71 may be adjusted by means of mechanical learning such as AdaBoost, using the supervised data including the various image data regarding the pedestrian and image data regarding regions posing no danger of collision with the own vehicle. In particular, in the case of using the object position detection unit 1111 in some embodiments, the supervised data may include the various image data regarding the pedestrian as well as the image data regarding regions posing no danger of collision but likely to be false detected by a millimeter wave radar or a laser radar, such as a pedestrian crossing, a manhole and a cat's eye.

In Step S41 of the present embodiment, the image IMGSRC[x][y] is magnified or demagnified so as to set the object in the processing region (SX, SY, EX, EY) in the predetermined size, but the identifier 71 may be magnified or demagnified instead of magnifying or demagnifying the image.

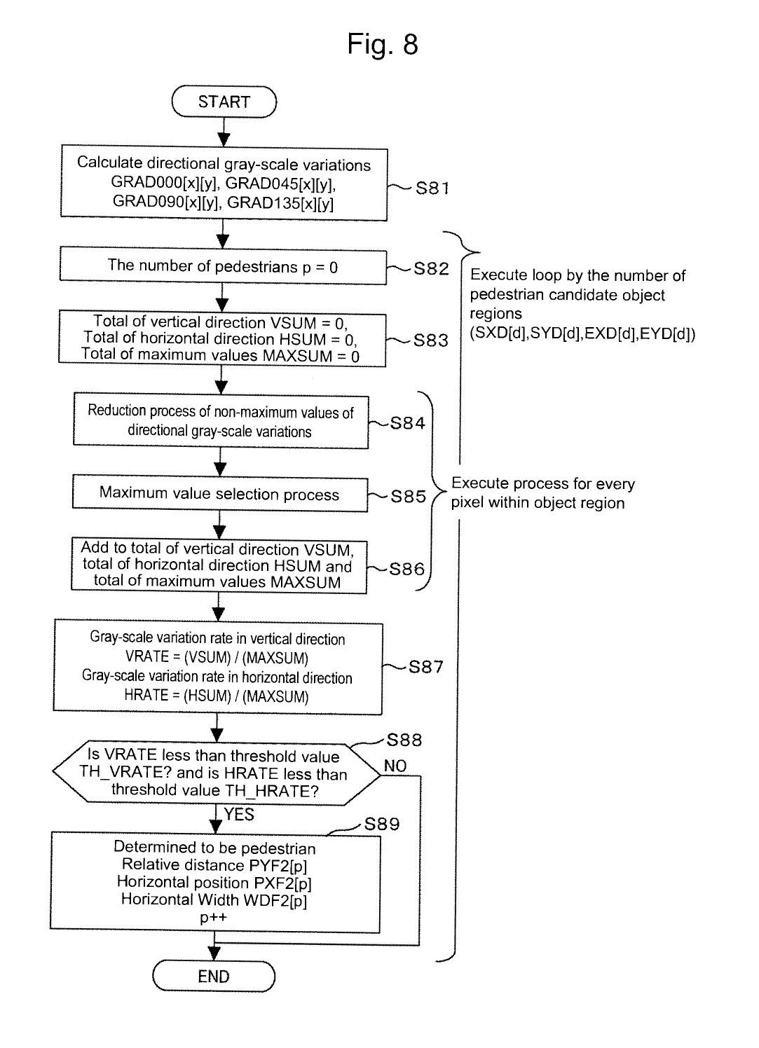

Descriptions will now be provided on the process of the pedestrian determination unit 1041. FIG. 8 is a flow chart of the process of the pedestrian determination unit 1041.

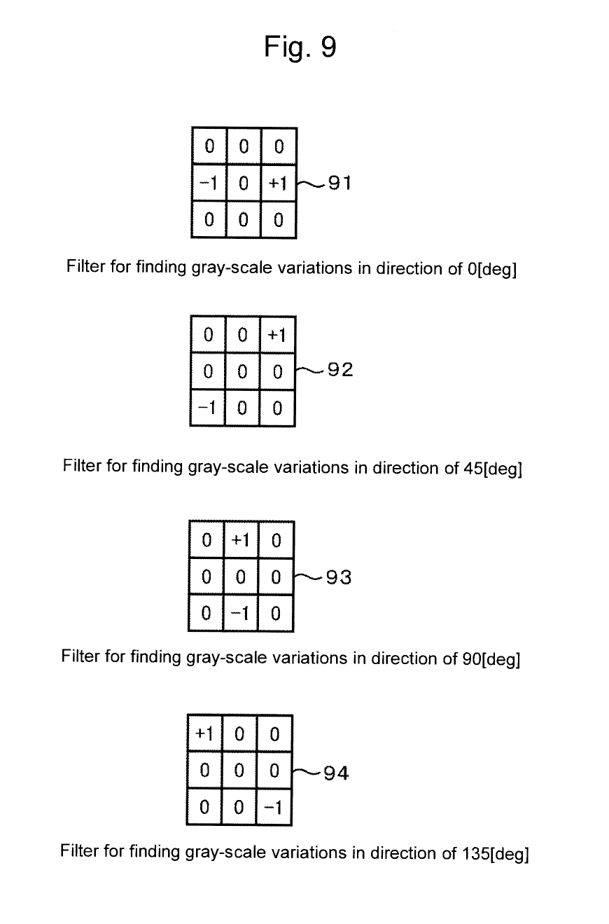

First, in Step 81, the filter for calculating the gray-scale variations in the predetermined direction is so applied to the image IMGSRC[x][y] as to find the degree of the gray-scale variations in the predetermined direction of this image. Using the example of the filter illustrated in FIG. 9, how to calculate the gray-scale variations in the four directions will be described, as follows.

The 3×3 filters of FIG. 9 include four kinds of filters: a filter 91 for finding the gray-scale variations in the direction of O[°], a filter 92 for finding the gray-scale variations in the direction of 45[°], a filter 93 for finding the gray-scale variations in the direction of 90[°] and a filter 94 for finding the gray-scale variations in the direction of 135[°], in order from the top. For example, as similar to the case of using the Sobel filter in FIG. 5, if the filter 91 for finding the gray-scale variations in the direction of 0[°] is applied to the image IMGSRC[x][y], the following calculation is executed for every pixel in the image IMGSRC[x][y]: the pixel values of nine pixels in total consisting of one pixel of interest and its neighboring eight pixels are subjected to a product sum operation with the respective weights of filter 91 for finding the gray-scale variations in the direction of 0[°] at the corresponding positions, so as to find the absolute value. This absolute value is the gray-scale variations in the direction of 0[°] in the pixel (x, y), and is stored in the GRAD000[x][y]. The same calculations are also applied to the other three filters, and the results are stored in the GRAD045[x][y], the GRAD090[x][y] and the GRAD135[x][y], respectively.

Each of the directional gray-scale variations GRAD000[x][y], GRAD045[x][y], GRAD090[x][y] and GRAD135[x][y] is a 2D array having the same size as the image IMGSRC[x][y], and the respective coordinates (x, y) of the GRAD000[x][y], GRAD045[x][y], GRAD090[x][y] and GRAD135[x][y] are corresponding to the coordinates (x, y) of the IMGSRC[x][y].

Before executing the calculation of the directional gray-scale variations, the image IMGSRC[x][y] may be cut out and magnified or demagnified so as to set the object in the image in the predetermined size. In the present embodiment, the above described calculation of the directional gray-scale variations is carried out without magnifying or demagnifying the image.

The calculation of the directional gray-scale variations GRAD000[x][y], GRAD045[x][y], GRAD090[x][y] and GRAD135[x][y] may be limited only within the range of the pedestrian candidate region (SXD[d], SYD[d], EXD[d], EYD[d]) or limited within the range of the processing region (SX, SY, EX, EY), and the calculation results out of these ranges may all be set to 0.

Next, in Step S82, the number of the pedestrians p is set to p=0, and the process from Steps S83 to S89 is executed for each pedestrian candidate region (SXD[d], SYD[d], EXD[d], EYD[d]).

In Step S83, the initialization is first executed by substituting the value of 0 for the total of the gray-scale variations in the vertical direction VSUM, the total of the gray-scale variations in the horizontal direction HSUM and the total of the gray-scale variations of the maximum values MAXSUM.

Next, the process from Steps S84 to S86 is executed for every pixel (x, y) in the current pedestrian candidate region.

In Step S84, the respective orthogonal components are first subtracted from the directional gray-scale variations GRAD000[x][y], GRAD045[x][y], GRAD090[x][y] and GRAD135[x][y], so as to reduce the non-maximum values of the GRAD000[x][y], GRAD045[x][y], GRAD090[x][y] and GRAD135[x][y]. The respective directional gray-scale variations GRAD000_S, GRAD045_S, GRAD090_S and GRAD135_S after the non-maximum values are reduced are calculated by using the following formulas (3) to (6).

(Formula 3)

GRAD000_{—}S=GRAD000[x][y]−GRAD090[x][y] (3)

(Formula 4)

GRAD045_{—}S=GRAD045[x][y]−GRAD135[x][y] (4)

(Formula 5)

GRAD090_{—}S=GRAD090[x][y]−GRAD000[x][y] (5)

(Formula 6)

GRAD135_{—}S=GRAD135[x][y]−GRAD045[x][y] (6)

Where, 0 is substituted for a value in minus.

Next, in Step S85, the maximum vale GRADMAX_S is found based on the directional gray-scale variations GRAD000_S, GRAD045_S, GRAD090_S and GRAD135_S after the non-maximum values are reduced, and all the values among the GRAD000_S, GRAD045_S, GRAD090_S and GRAD135_S, which are smaller than the GRADMAX_S, are set to 0.

In Step S86, the above corresponding values are added to the total gray-scale variations in the vertical direction VSUM, the total gray-scale variations in the horizontal direction HSUM and the total gray-scale variations of maximum values MAXSUM by using the following formulas (7), (8), (9).

(Formula 7)

VSUM=VSUM+GRAD000_{—}S (7)

(Formula 8)

HSUM=HSUM+GRAD090_{—}S (8)

(Formula 9)

MAXSUM=MAXSUM+GRADMAX_{—}S (9)

Following the process from Steps S84 to S86 executed for every pixel in the current pedestrian candidate region, in Step S87, the gray-scale variation rate in the vertical direction VRATE and the gray-scale variation rate in the horizontal direction HRATE are calculated by using the following formulas (10), (11).

(Formula 10)

VRATE=VSUM/MAXSUM (10)

(Formula 11)

HRATE=HSUM/MAXSUM (11)

In Step S88, it is determined whether or not the calculated gray-scale variation rate in the vertical direction VRATE is less than the predefined threshold value TH_VRATE# and the calculated gray-scale variation rate in the horizontal direction HRATE is less than the predefined threshold value TH_HRATE#, and if both rates are less than the respective threshold values, the process shifts to Step S89.

In Step S89, the pedestrian candidate region (SXD[d], SYD[d], EXD[d], EYD[d]) determined to be the pedestrian as well as the pedestrian candidate object information (relative distance PYF1[d], horizontal position PXF1[d], horizontal width WDF1[d]), which are calculated at the pedestrian candidate setting unit, are substituted for the pedestrian region (SXP[p], SYP[p], EXP[p], EYP[p]) and the pedestrian object information (relative distance PYF2[p], horizontal position PXF2[p], horizontal width WDF2[p]), and then the p is incremented. In Step S88, if the pedestrian candidate region is determined to be the artificial object, no process is executed.

The process from Steps S82 to S89 is repetitively executed by the number of the pedestrian candidates d=0, 1 . . . detected at the pedestrian candidate setting unit 1031, and the process by the pedestrian determination unit 1041 is completed.

In the present embodiment, the gray-scale variation rate in the vertical direction VRATE and the gray-scale variation rate in the horizontal direction HRATE are calculated based on the pedestrian candidate region (SXD[d], SYD[d], EXD[d], EYD[d]), but this calculation may be executed limitedly in a predetermined area in the pedestrian candidate region (SXD[d], SYD[d], EXD[d], EYD[d]).

For example, the gray-scale variations in the vertical direction of a utility pole appear outside the center of the pedestrian candidate region, and thus the calculation of the total gray-scale variations in the vertical direction VSUM is executed limitedly in areas in the neighborhood of the right outside and left outside boundaries of the pedestrian candidate region.

The gray-scale variations in the horizontal direction of a guardrail appear below the center of the pedestrian candidate region, and thus the calculation of the total gray-scale variations in the horizontal direction HSUM is executed limitedly in lower area in the pedestrian candidate region.

Weights of other filters than those illustrated in FIG. 9 may be used for the weights of the filters for calculating the directional gray-scale variations illustrated in FIG. 9.

For example, the weights of the Sobel filter illustrated in FIG. 5 may be used for the 0[°] direction and the 90[°] direction, and rotated values from the weights of the Sobel filter may be used for the 45[°] direction and the 135[°] direction.

Methods other than the above described methods may also be used for the calculations of the gray-scale variation rate in the vertical direction VRATE and the gray-scale variation rate in the horizontal direction HRATE. The process of reducing the non-maximum values may be omitted, and the process of setting the values other than the maximum values to 0 may be omitted.

The threshold values TH_VRATE#, TH_HRATE# can be determined by calculating the gray-scale variation rate in the vertical direction VRATE and the gray-scale variation rate in the horizontal direction HRATE based on the pedestrian and the artificial object detected in advance at the pedestrian candidate setting unit 1031.

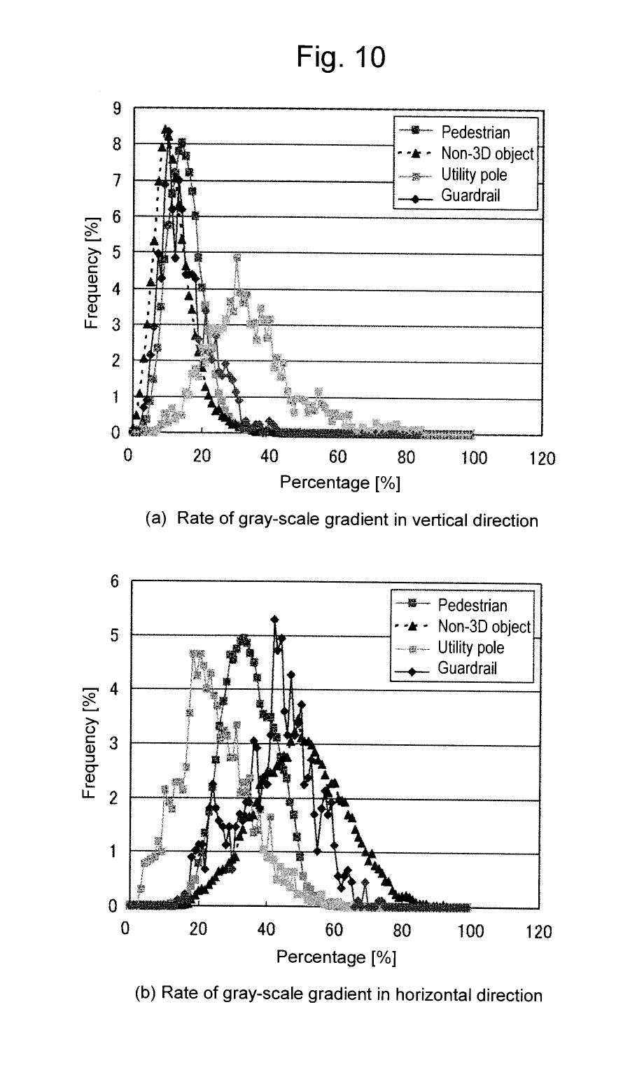

FIG. 10 illustrates the example of calculating the gray-scale variation rate in the vertical direction VRATE and the gray-scale variation rate in the horizontal direction HRATE based on the plural kinds of objects detected at the pedestrian candidate setting unit 1031.

As illustrated in the drawing, in the gray-scale variation rate in the vertical direction VRATE, the distributions of the utility pole depart from the distributions of the pedestrian; and in the gray-scale variation rate in the horizontal direction HRATE, the distributions of the non-3D dimensional objects such as a guardrail and road paintings depart from the distributions of the pedestrian. If providing a threshold value between these distributions, the gray-scale variation rate in the vertical direction VRATE can reduce false determination for an utility pole as the pedestrian, and the gray-scale variation rate in the horizontal direction HRATE can reduce false determination for non-3D dimensional objects such as a guardrail and road paintings as the pedestrian.

The determinations of the gray-scale variation rates in the vertical and horizontal directions may be carried out by using methods other than those using the threshold values. For example, the respective gray-scale variation rates in the directions of 0[°], 45[°], 90[°] and 135[^{°}] are calculated to generate 4D vectors, and the determination of whether to be an utility pole or not is carried out depending on the distance from each vector to a representative vector calculated based on various utility poles (such as a mean vector), or the determination of whether to be a guardrail or not is similarly carried out depending on the distance from each vector to a representative vector of the guardrail.

As described above, the configuration including the pedestrian candidate setting unit 1031 for recognizing the pedestrian candidate by using the pattern matching method and also the pedestrian determination unit 1041 for determining whether to be the pedestrian or the artificial object based on the gray-scale variation rate can reduce false detections for artificial objects such as a utility pole, a guardrail and road paintings that have large amount of linear gray-scale variations.

Since the pedestrian determination unit 1041 uses the gray-scale variation rate, the processing load becomes smaller and the determination can be carried out in a shorter process period, so that it is possible to realize quick initial capture of the pedestrian running out in front the own vehicle.

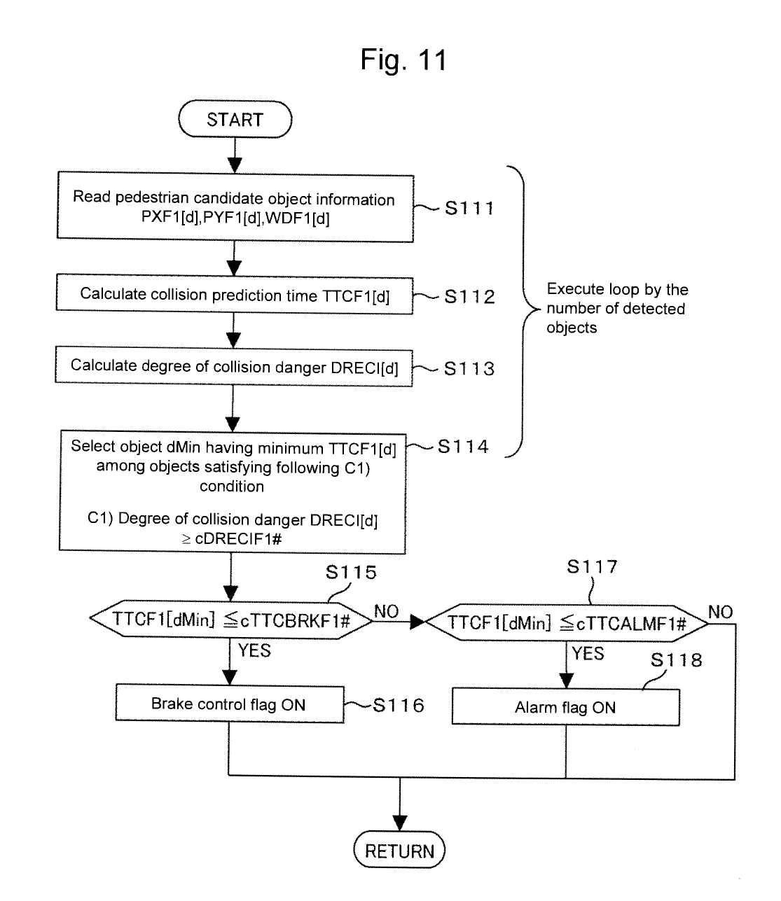

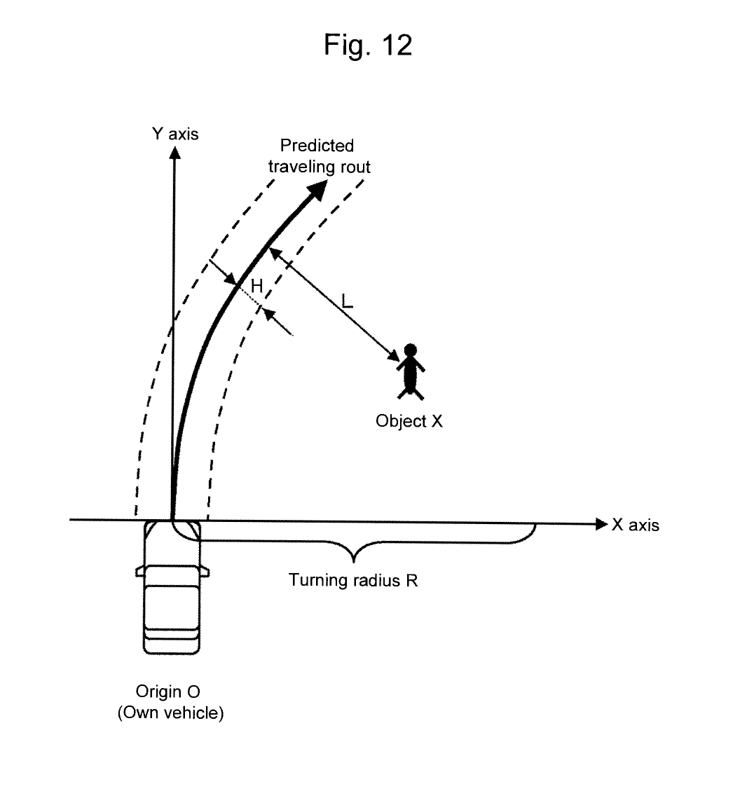

Descriptions will now be provided on the process of the first collision determination unit 1211 with reference to FIG. 11 and FIG. 12.

The first collision determination unit 1211 sets the alarm flag for activating an alarm or the brake control flag for activating an automatic brake control for reducing collision damage in accordance with the pedestrian candidate object information (PYF1[d], PXF1[d], WDF1[d]) detected at the pedestrian candidate setting unit 1031.

FIG. 11 is a flow chart of illustrating how to operate the pre-crash safety system.

In Step S111, the pedestrian candidate object information (PYF1[d], PXF1[d], WDF1[d]) detected at the pedestrian candidate setting unit 1031 is first read.

Next, in Step S112, the collision prediction time TTCF1[i] of each detected object is calculated by using the formula (12). The relative speed VYF1[d] is found by pseudo-differentiating the relative distance PYF1[d] of the object.

(Formula 12)

TTCF1[d]=PYF1[d]÷VYF1[d] (12)

In Step S113, the degree of collision danger DRECIF1[d] relative to each obstacle is further calculated.

An example of how to calculate the degree of collision danger DREC1[d] relative to the detected object X[d] will be described with reference to FIG. 12, as follows.

First, descriptions will be provided on the method of predicting the predicted traveling rout. As illustrated in FIG. 12, the predicted traveling rout can be approximated by an arc passing through the origin O with the turning radius R, where the origin O is the position of the own vehicle. The turning radius R is represented by the formula (13) using the steering angle α, the speed Vsp, the stability factor A, the wheelbase L and the steering gear ratio Gs of the own vehicle.

(Formula 13)

R=(1+AV2)×(L·Gs/α) (13)

The steering characteristics of a vehicle depend on whether the stability factor is positive or negative, and the stability factor is a critical value serving as an index to indicate a degree of change relying on the steady circular turning speed of the vehicle. As apparent in the formula (13), the turning radius R changes in proportion to the square of the own vehicle speed Vsp if having the stability factor A as a coefficient. The steering radius R can be expressed in the formula (14) using the vehicle speed Vsp and the yaw rate y.

(Formula 14)

R=V/γ (14)

Next, a perpendicular line is drawn from the object X[d] to the center of the predicted traveling rout approximated in the arc with the turning radius R, so as to find the distance L[d].

The distance L[d] is subtracted from the own vehicle width H, and if the value is a negative value, the degree of collision danger DRECI[d] is set to DRECI[d]=0, and if the value is a positive value, the degree of collision danger DRECI[d] is calculated by using the following formula (15).

(Formula 15)

DRECI[d]=(H−L[b])/H (15)

The process from Steps S111 to S113 is configured to execute the loop process by the number of the detected objects.

In Step S114, the objects that satisfy the condition of the formula (16) are selected in accordance with the degree of collision danger DRECI[d] calculated in Step S113, and then the object dMin having the minimum collision prediction time TTCF1[d] is selected among the selected objects.

(Formula 16)

DRECI[d]≧cDRECIF1# (16)

Where the predetermined value cDRECIF1# is a threshold value used for determining whether or not the selected object will collide with the own vehicle.

Next, in Step S115, it is determined whether or not the selected object is within the range where the automatic brake should be controlled in accordance with the collision prediction time TTCF1[dMin] of the selected object. If the Formula (17) is satisfied, the process shifts to Step S116, where the brake control flag is set to ON, and then the process is completed. If the Formula (17) is unsatisfied, the process shifts to Step S117.

(Formula 17)

TTCF1[dMin]≦cTTCBRKF1# (17)

In Step S117, it is determined whether or not the selected object is within the range where the alarm should be output in accordance with the collision prediction time TTCF1[dMin] of the selected object dMin.

If the following Formula (18) is satisfied, the process shifts to Step S118, where the alarm flag is set to ON and then the process is completed. If the Formula (18) is unsatisfied, neither the brake control flag nor the alarm flag are set, and then the process is completed.

(Formula 18)

TTCF1[dMin]≦cTTCALMF1# (18)

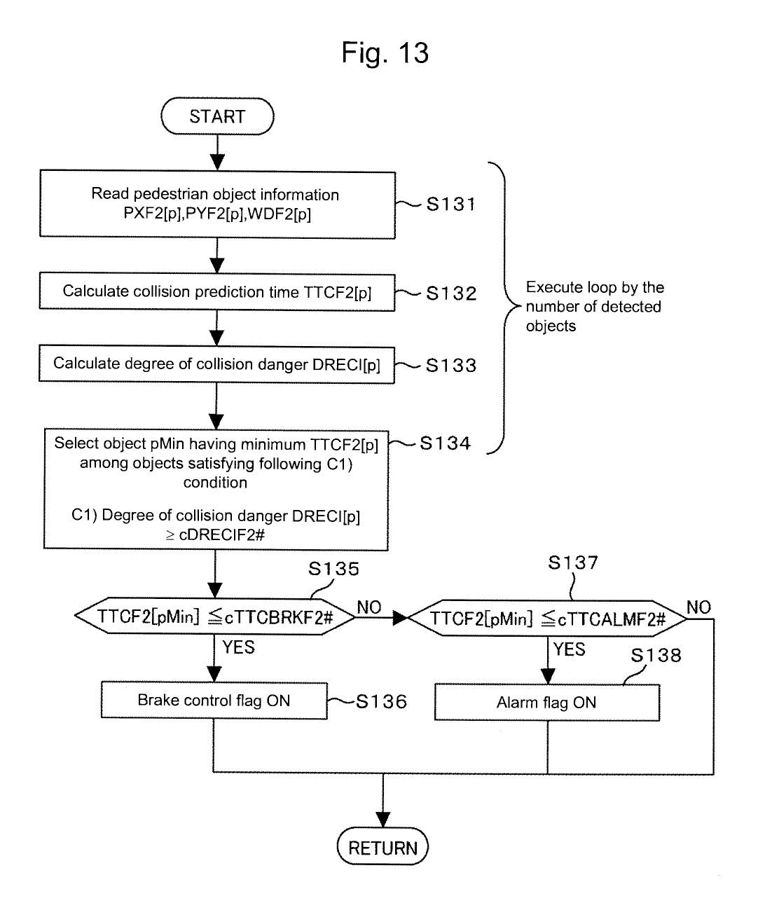

Descriptions will be now provided on the second collision determination unit 1221 with reference to FIG. 13.

The second collision determination unit 1221 sets the alarm flag for activating an alarm or the brake control flag for activating an automatic brake control for reducing collision damage depending on the pedestrian object information (PYF2[p], PXF2[p], WDF2[p]) regarding the pedestrian that is determined as the pedestrian at the pedestrian determination unit 1041.

FIG. 13 is a flow chart of illustrating how to operate the pre-crash safety system.

First, in Step S131, the pedestrian object information (PYF2[p], PXF2[p], WDF2[p]) regarding the pedestrian that is determined as the pedestrian at the pedestrian determination unit 1041 is read.

Next, in Step S132, the collision prediction time TTCF2[p] of each detected object is calculated by using the following Formula (19). The relative speed VYF2[p] is found by pseudo-differentiating the relative distance PYF2[p] of the object.

(Formula 19)

TTCF2[p]=PYF2[p]÷VYF2[p] (19)

In Step S133, the degree of collision danger DRECI[p] relative to each obstacle is further calculated. The process of calculating the degree of collision danger DRECI[p] is the same as the above descriptions on the first collision determination unit, therefore the descriptions thereof will be omitted.

The process from Steps S131 to S133 is configured to execute the loop process by the number of the detected objects.

In Step S134, the objects that satisfy the condition of the following Formula (20) are selected in accordance with the degree of collision danger DRECI[p] calculated in Step S133, and then the object pMin having the minimum collision prediction time TTCF2[p] is selected among the selected objects.

(Formula 20)

DRECI[p]≧cDRECIF2# (20)

Where the predetermined value cDRECIF2# is a threshold value used for determining whether or not the selected object will collide with the own vehicle.

Next, in Step S135, it is determined whether or not the selected object is within the range where the automatic brake should be controlled in accordance with the collision prediction time TTCF2[pMin] of the selected object. If the following Formula (21) is satisfied, the process shifts to Step S136, where the brake control flag is set to ON, and then the process is completed. If the Formula (21) is unsatisfied, the process shifts to Step S137.

(Formula 21)

TTCF2[pMin]≦cTTCBRKF2# (21)

In Step S137, it is determined whether or not the selected object is within the range where the alarm should be output in accordance with the collision prediction time TTCF2[pMin] of the selected object pMin. If the following Formula (22) is satisfied, the process shifts to Step S138, where the alarm flag is set to ON and then the process is completed.

If the Formula (22) is unsatisfied, neither the brake control flag nor the alarm flag are set, and the process is completed.

(Formula 22)

TTCF2[pMin]≦cTTCALMF2# (22)

As described above, the configuration of including the first collision determination unit 1211 and the second collision determination unit 1221 and of setting the conditions of cTTCBRKF1#<cTTCBRKF2# and cTTCALMF1#<cTTCALMF2# enables such a control that activates the alarm and the brake control for the object likely to be the pedestrian detected at the pedestrian candidate setting unit 1031 only from the vicinity of the object, and also such a control that activates the alarm and the brake control for the object determined to be the pedestrian at the pedestrian determination unit 1041 from the distance to the object.

As described above, in particular if the identifier 71 of the pedestrian candidate setting unit 1031 is adjusted by using the image data regarding the pedestrian and the image data regarding the region where there is no danger of collision with the own vehicle, the object detected at the pedestrian candidate setting unit 1031 is a 3D object including the pedestrian; thus there is a danger of collision with the own vehicle. Accordingly, even if the pedestrian determination unit 1041 determines that the detected object is not the pedestrian, the above control can be activated only in the vicinity of the pedestrian, thereby contributing to reduction of traffic accidents.

A dummy of the pedestrian is prepared and the environment recognizing device for a vehicle 1000 is mounted on a vehicle, and when this vehicle is caused to move toward the dummy, the alarm and the control are activated at certain timing. Meanwhile, if a fence is disposed in front of the dummy and the vehicle is similarly caused to move toward the dummy, the alarm and the control are activated at the timing later than the former timing because the gray-scale variations in the vertical direction are increased in the camera image.

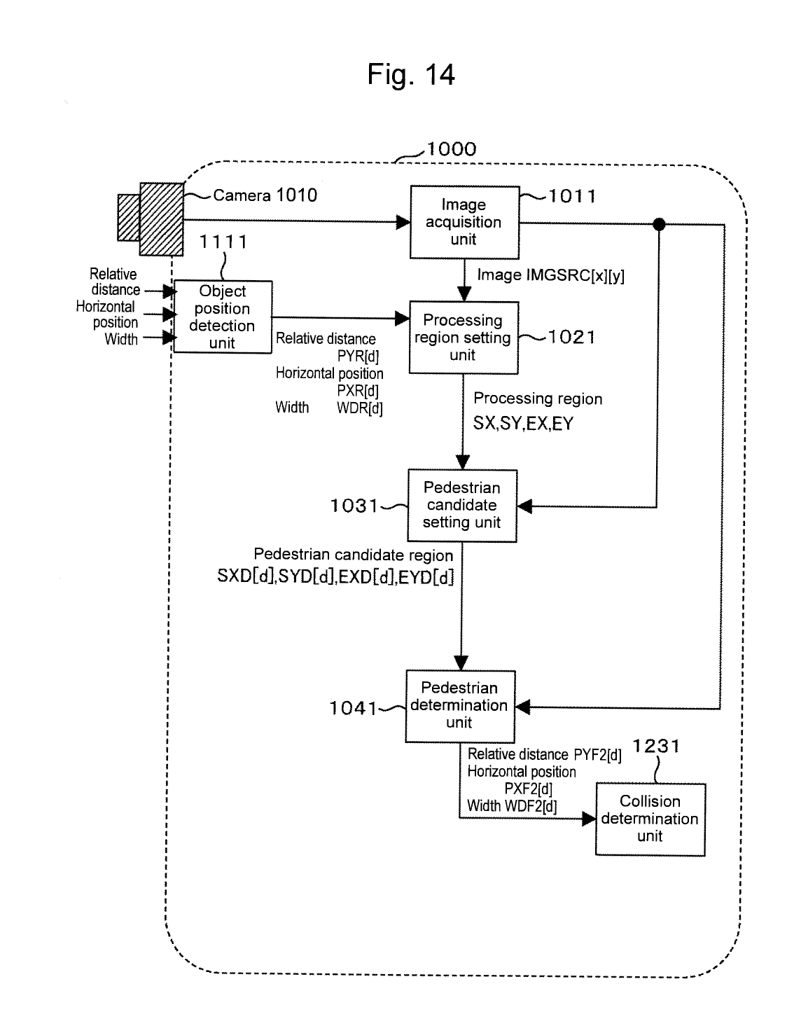

In the environment recognizing device for a vehicle 1000 of the present invention, such an embodiment as illustrated in FIG. 14 may be accomplished that includes neither the first collision determination unit 1211 nor the second collision determination unit 1221 but includes the collision determination unit 1231.

The collision determination unit 1231 calculates the degree of collision danger depending on the pedestrian object information (relative distance PYF2[p], horizontal position PXF2[p], horizontal width WDF2[p]) detected at the pedestrian determination unit 1041, and determines the necessity of activating the alarm and the brake in accordance with the degree of collision danger. The determination process is the same as that of the second collision determination unit 1221 of the environment recognizing device for a vehicle 1000, and thus the descriptions thereof will be omitted.

The embodiment of the environment recognizing device for a vehicle 1000 illustrated in FIG. 14 is supposed that the pedestrian determination unit eliminates a false detection for road paintings. A false detection for the road paintings that cannot be removed at the pedestrian candidate setting unit 1031 is eliminated at the pedestrian determination unit 1041, and the collision determination unit 1231 executes the alarm and the automatic brake control based on the result from the pedestrian determination unit 1041.

As described above, the pedestrian determination unit 1041 can reduce false detections for artificial objects such as a utility pole, a guardrail and road paintings, using the gray-scale variations in the vertical and horizontal directions.

Road paintings pose no danger of collision with the own vehicle, and if road paintings are determined to be the pedestrian, the automatic brake and other functions are activated at a location where there is no danger of collision with the own vehicle, which deteriorates the safety of the own vehicle.

A utility pole or a guardrail poses a danger of collision with the own vehicle, and is a still object, which is different from the pedestrian movable laterally or longitudinally. If the alarm is activated for such a still object at the same timing of avoiding the pedestrian, the alarming operation is executed too early to a driver, which irritates the driver.

Employing the present invention can solve the above described problems that deteriorate the safety and irritate a driver.

The present invention detects the candidates including the pedestrian by using the pattern matching method, and further determines whether or not the candidates are the pedestrian using the gray-scale variation rate in the predetermined direction in the detected region, so as to reduce the processing load in the following process, thereby detecting the pedestrian at high speed. As a result, the speed of the processing period can be enhanced, which enables quicker initial capture of the pedestrian running out in front of the own vehicle.

Hereinafter, descriptions will be provided on the second embodiment of an environment recognizing device for a vehicle 2000 of the present invention with reference to the drawings.

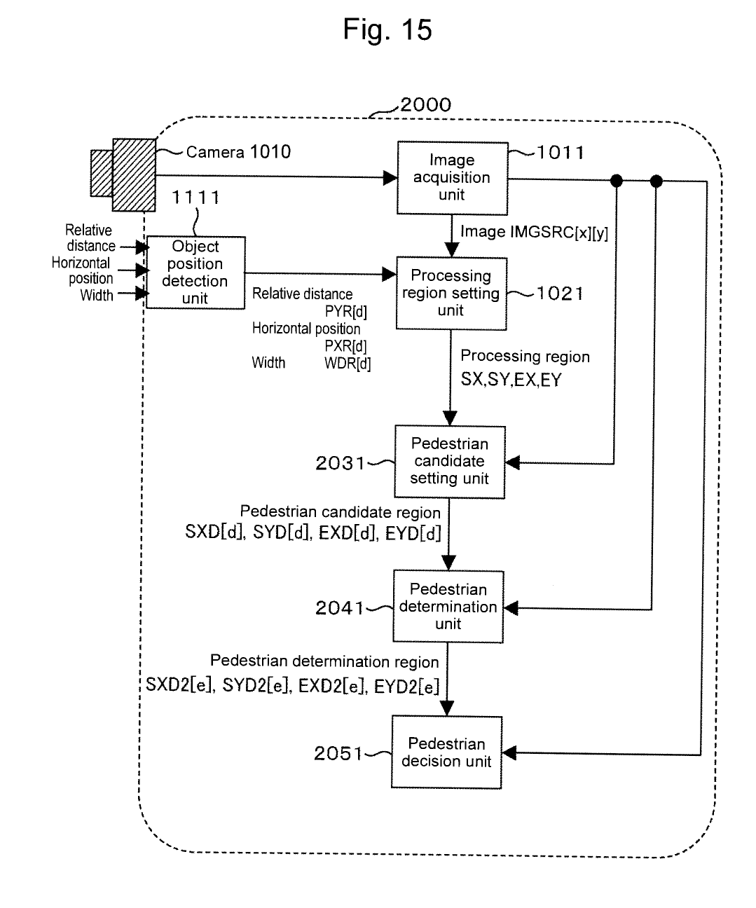

FIG. 15 is a block diagram of illustrating the embodiment of the environment recognizing device for a vehicle 2000. In the following descriptions, only the elements different from those of the environment recognizing device for a vehicle 1000 will be described in detail, and the same reference numerals will be given to the same elements and any detailed explanation will be omitted.

The environment recognizing device for a vehicle 2000 is configured to be embedded in the camera mounted on the vehicle or in an integrated controller or the like, and to detect preset objects from an image picked up by the camera 1010, and in the present embodiment, is configured to detect a pedestrian from a picked up image in front of the own vehicle.

The environment recognizing device for a vehicle 2000 includes a computer having a CPU, memories, I/O and other components, in which predetermined processes are programmed so as to be repetitively executed in predetermined cycles. As illustrated in FIG. 15, the environment recognizing device for a vehicle 2000 includes the image acquisition unit 1011, the processing region setting unit 1021, a pedestrian candidate setting unit 2031, a pedestrian determination unit 2041 and a pedestrian decision unit 2051, and further includes the object position detection unit 1111 in some embodiment.

The pedestrian candidate setting unit 2031 sets the pedestrian candidate regions (SXD[d], SYD[d], EXD[d], EYD[d]) used for determining the existence of the pedestrian from the processing region (SX, SY, EX, EY) set at the processing region setting unit 1021. The details of the process will be described later.

The pedestrian determination unit 2041 calculates four kinds of gray-scale variations in the 0 degree direction, the 45 degree direction, the 90 degree direction and the 135 degree direction from the image IMGSRC[x][y], and generates the directional gray-scale variation images (GRAD000[x][y], GRAD045[x][y], GRAD090[x][y], GRAD135[x][y]).

Next, the pedestrian determination unit 2041 calculates the gray-scale variation rate in the vertical direction RATE_V and the gray-scale variation rate in the horizontal direction RATE_H based on the directional gray-scale variation images (GRAD000[x][y], GRAD045[x][y], GRAD090[x][y], GRAD135[x][y]) in the pedestrian candidate regions (SXD[d], SYD[d], EXD[d], EYD[d]), and determines that the pedestrian candidate region of interest is the pedestrian if both the rate values are smaller than the threshold values cTH_RATE_V and cTH_RATE_H, respectively. If the pedestrian candidate region of interest is determined to be the pedestrian, this pedestrian candidate region is set to be the pedestrian determination region (SXD2[e], SYD2[e], EXD2[e], EYD2[e]). Detailed descriptions will be provided on the determination later.

The pedestrian decision unit 2051 first calculates the gray-scale gradient value from the image IMGSRC[x][y], and generates the binary edge image EDGE[x][y] and the gradient direction image DIRC[x][y] having information regarding the edge direction.

Next, in the pedestrian determination region (SXD2[e], SYD2[e], EXD2[e], EYD2[e]) of interest, the pedestrian decision unit 2051 sets the matching determination regions (SXG[g], SYG[g], EXG[g], EYG[g]) used for determining the pedestrian in the edge image EDGE[x][y], and uses the edge image EDGE[x][y] in the matching determination region of interest and the gradient direction image DIRC[x][y] in the region at the corresponding position, so as to recognize the pedestrian. The g denotes an ID number if plural regions are set. The recognizing process will be described in detail later.

Among the matching determination regions, the region recognized to be a pedestrian is stored as the pedestrian candidate region (SXD[d], SYD[d], EXD[d], EYD[d]) and as the pedestrian object information (relative distance PYF2[d], horizontal position PXF2[d], horizontal width WDF2[d]). The d denotes an ID number if plural objects are set.

The process of the pedestrian candidate setting unit 2031 will now be described.

The pedestrian candidate setting unit 2031 sets the region to be processed at the pedestrian determination unit 2041 and the pedestrian decision unit 2051 within the processing region (SX, EX, SY, EY).

Using the distance of the processing region (SX, EX, SY, EY) and the camera geometric parameters set by the processing region setting unit 1021, the size in the image corresponding to the assumed height (180 cm in the present embodiment) and width (60 cm in the present embodiment) of the pedestrian are first calculated.

Next, the calculated height and width of the pedestrian in the image are set in the processing region (SX, EX, SY, EY) with being shifted by one pixel, and these set regions are defined as the pedestrian candidate regions (SXD[d], SYD[d], EXD[d], EYD[d]).

The respective pedestrian candidate regions (SXD[d], SYD[d], EXD[d], EYD[d]) may be arranged with slipping several pixels therebetween, or the setting of the pedestrian candidate regions may be limited by the preprocess in which the pedestrian candidate region is not set if total pixels of the image IMGSRC[x][y] within the region becomes 0, for example.

The descriptions will now be provided on the pedestrian determination unit 2041.

For each of the pedestrian candidate regions (SXD[d], SYD[d], EXD[d], EYD[d]), the pedestrian determination unit 2041 performs the same determination operation as that performed by the pedestrian determination unit 1041 of the environment recognizing device for a vehicle 1000, and if the pedestrian candidate region (SXD[d], SYD[d], EXD[d], EYD[d]) of interest is determined to be the pedestrian, this determined candidate region is substituted for the pedestrian determination region (SXD2[e], SYD2[e], EXD2[e], EYD2[e]), and is output to the following process. The details of the process are the same as those of the pedestrian determination unit 1041 of the environment recognizing device for a vehicle 1000, and thus the descriptions of this process will be omitted.

Descriptions will now be provided on the pedestrian decision unit 2051.

For each of the pedestrian determination regions (SXD2[e], SYD2[e], EXD2[e], EYD2[e]), the pedestrian decision unit 2051 performs the same process as that performed by the pedestrian candidate setting unit 1031 of the environment recognizing device for a vehicle 1000, and if the pedestrian determination region (SXD2[e], SYD2[e], EXD2[e], EYD2[e]) of interest is determined to be the pedestrian, the pedestrian object information (relative distance PYF2[p], horizontal position PXF2[p], horizontal width WDF2[p]) is output. Specifically, the pedestrian decision unit 2051 decides the existence of the pedestrian in the pedestrian determination regions (SXD2[e], SYD2[e], EXD2[e], EYD2[e]) determined to be the pedestrian at the pedestrian determination unit 2041, by using the identifier generated by the off-line learning.

The detailed process will now be provided with reference to the flow chart of FIG. 4.

First, in Step S41, the edges are extracted from the image IMGSRC[x][y]. The calculation methods of the edge image EDGE[x][y] and the gradient direction image DIRC[x][y] are the same as the calculations of the pedestrian candidate setting unit 1031 of the environment recognizing device for a vehicle 1000, and thus the descriptions thereof will be omitted.

Before the edge extraction, the image IMGSRC[x][y] may be cut out, and the object in the image may be magnified or demagnified in the predetermined size. In the present embodiment, the above described edge calculation is performed by using the distance information and the camera geometry used at the processing region setting unit 1021 so as to magnify or demagnify the image such that every object in the image IMGSRC[x][y] having the height of 180 [cm] and the width of 60 [cm] in the size of 16 dots×12 dots.

The calculations of the edge image EDGE[x][y] and the gradient direction image DIRC[x][y] are executed limitedly within the range of the processing region (SX, EX, SY, EY) or within the pedestrian determination region (SXD2[e], SYD2[e], EXD2[e], EYD2[e]), and values for the other portions out of the ranges may all be set to 0.

Next, in Step S42, the matching determination regions (SXG[g], SYG[g], EXG[g], EYG[g]) used for the pedestrian determination are set in the edge image EDGE[x][y].

Regarding matching determination regions (SXG[g], SYG[g], EXG[g], EYG[g]), if the image is previously magnified or demagnified at the time of the edge extraction in Step S41, the pedestrian determination regions (SXD2[e], SYD2[e], EXD2[e], EYD2[e]) are converted into coordinates in the demagnified image, and each of the regions is set to be the matching determination region (SXG[g], SYG[g], EXG[g], EYG[g]).

In the present embodiment, the camera geometry is used so as to magnify or demagnify the image such that every object in the image IMGSRC[x][y] having the height of 180 [cm] and the width of 60 [cm] into the size of 16 dots×12 dots, thereby generating the edge image.

The coordinates of the pedestrian determination regions (SXD2[e], SYD2[e], EXD2[e], EYD2[e]) are magnified or demagnified at the same percentage of the magnification or demagnification of the image, thereby setting the pedestrian determination regions as the matching determination regions (SXG[g], SYG[g], EXG[g], EYG[g]).

If the image is not magnified or demagnified in advance at the time of the edge extraction in Step S41, the pedestrian determination regions (SXD2[e], SYD2[e], EXD2[e], EYD2[e]) are directly set to be the matching determination regions (SXG[g], SYG[g], EXG[g], EYG[g]).

The process in and after Step S43 is the same as that of the pedestrian candidate setting unit 1031 of the environment recognizing device for a vehicle 1000, and thus the descriptions of this process will be omitted.

Descriptions will be provided on the third embodiment of an environment recognizing device for a vehicle 3000 of the present invention with reference to the drawings.

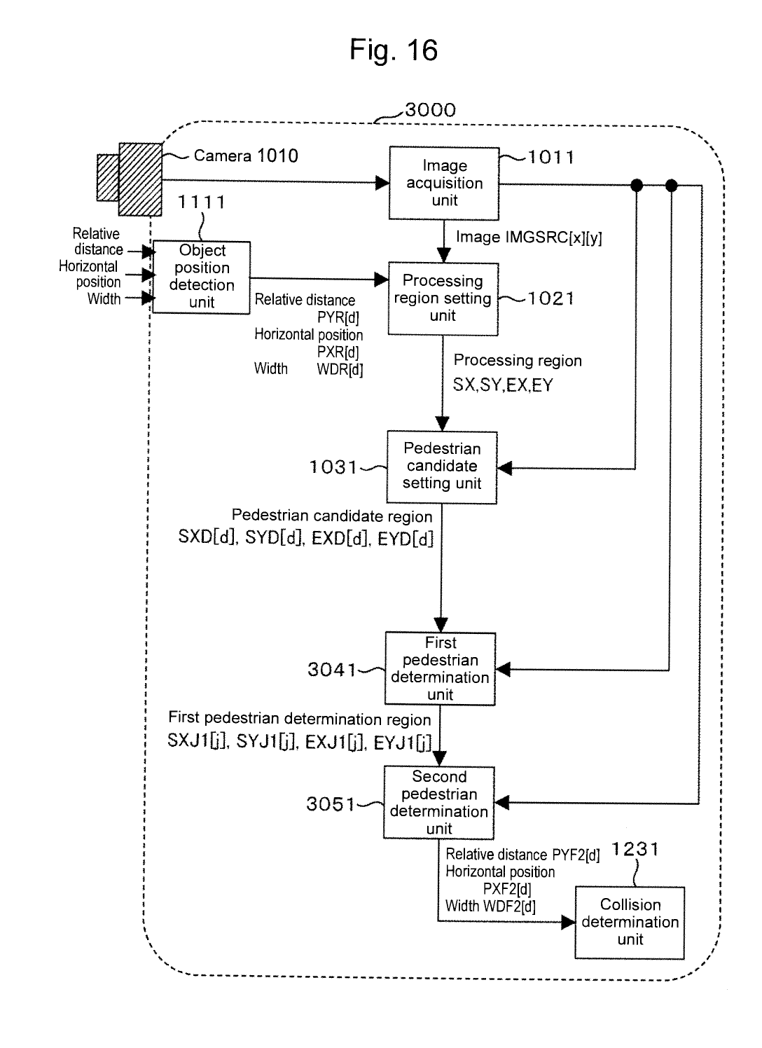

FIG. 16 is a block diagram of illustrating the embodiment of the environment recognizing device for a vehicle 3000.

In the following descriptions, only the elements different from those of the environment recognizing device for a vehicle 1000 and the environment recognizing device for a vehicle 2000 will be described in detail, and the same reference numerals will be given to the same elements and any detailed explanation will be omitted.

The environment recognizing device for a vehicle 3000 is configured to be embedded in the camera mounted on the vehicle or in an integrated controller or the like, and to detect preset objects from an image picked up by the camera 1010, and in the present embodiment, is configured to detect a pedestrian from a picked up image in front of the own vehicle.

The environment recognizing device for a vehicle 3000 includes a computer having a CPU, memories, I/O and other components, in which predetermined processes are programmed so as to be repetitively executed in predetermined cycles.

As illustrated in FIG. 16, the environment recognizing device for a vehicle 3000 includes the image acquisition unit 1011, the processing region setting unit 1021, the pedestrian candidate setting unit 1031, a first pedestrian determination unit 3041, a second pedestrian determination unit 3051, and the collision determination unit 1231, and further includes the object position detection unit 1111 in some embodiments.

For each of the pedestrian candidate regions (SXD[d], SYD[d], EXD[d], EYD[d]), the first pedestrian determination unit 3041 performs the same determination as the determination performed by the pedestrian determination unit 1041 of the environment recognizing device for a vehicle 1000, and if the pedestrian candidate region (SXD[d], SYD[d], EXD[d], EYD[d]) of interest is determined to be the pedestrian, the determined pedestrian candidate region (SXD[d], SYD[d], EXD[d], EYD[d]) is substituted for the first pedestrian determination region (SXJ1[j], SYJ1[j], EXJ1[j], EYJ1[j]) and is output to the following process. The details of the process are the same as those of the pedestrian determination unit 1041 of the environment recognizing device for a vehicle 1000, and thus the descriptions of this process will be omitted.

For each of the first pedestrian determination regions (SXJ1[j], SYJ1[j], EXJ1[j], EYJ1[j]), the second pedestrian determination unit 3051 counts the number of pixels having equal to or more than the predetermined luminance threshold value, in the image IMGSR[x][y] at the corresponding position to the first pedestrian determination region of interest; and if the total of the counted pixels are equal to or less than the predetermined area threshold value, this region of interest is determined to be the pedestrian. The region determined as the pedestrian is stored as the pedestrian object information (relative distance PYF2[p], horizontal position PXF2[p], horizontal width WDF2[p]) and is used at the collision determination unit 1231 in the following process.

That is, the first pedestrian determination unit 3041 determines whether the pedestrian candidate region (SXD[d], SYD[d], EXD[d], EYD[d]) of interest is the pedestrian or the artificial object depending on the gray-scale variation rate in the predetermined direction within the pedestrian candidate region of interest, and the second pedestrian determination unit 3051 determines whether the pedestrian determination region (SXJ1[j], SYJ1[j], EXJ1[j], EYJ1[j]) of interest determined to be the pedestrian at the first pedestrian determination unit 3041 is the pedestrian or the artificial object based on the number of the pixels having values equal to or more than the predetermined luminance threshold value within the pedestrian determination region of interest.

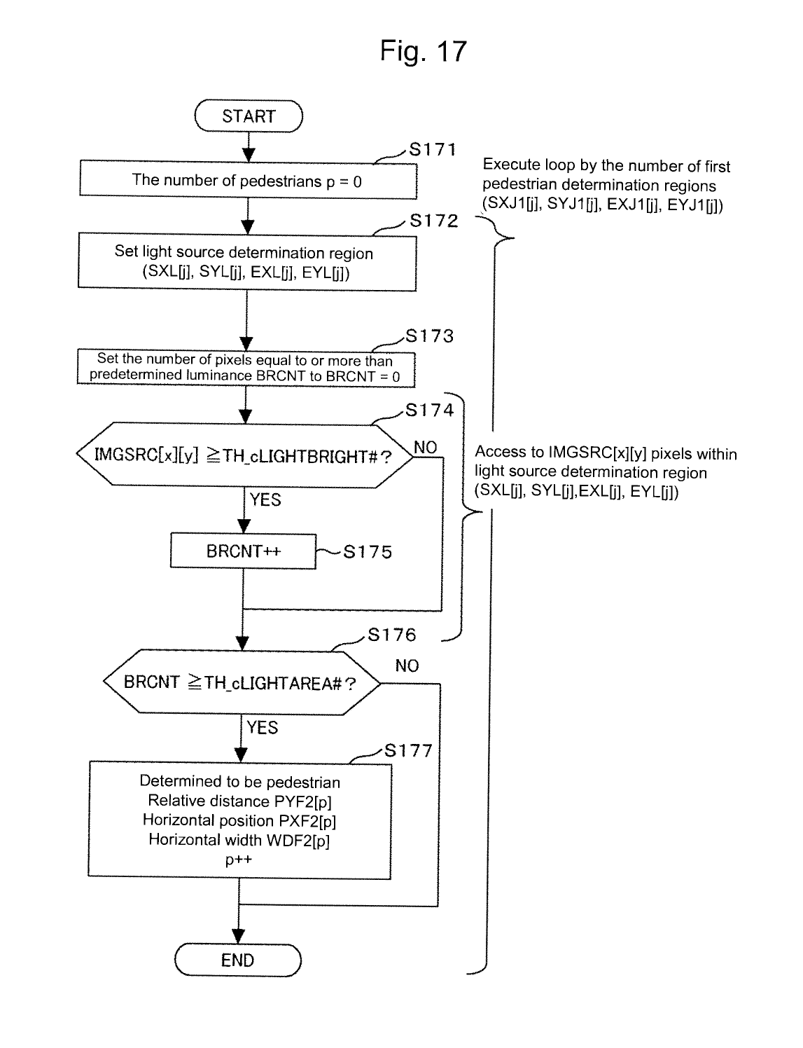

The descriptions will now be provided on the process by the second pedestrian determination unit 3051. FIG. 17 is a flow chart of the second pedestrian determination unit 3051.

First, in Step S171, the number of the pedestrians p is set to p=0, and the processes in and after Step S172 are repetitively performed by the number of the first pedestrian determination regions (SXJ1[j], SYJ1[j], EXJ1[j], EYJ1[j]).

In Step S172, the light source determination region (SXL[j], SYL[j], EXL[j], EYL[j]) is set in each of the first pedestrian determination region (SXJ1[j], SYJ1[j], EXJ1[j], EYJ1[j]) of interest. This region can be calculated by using the camera geometry model based on the specification of the mounting position of a headlight that is a light source, which is 50 [cm] or more and 120 [cm] or less in Japan, for example. The width thereof is set to be a half of the width of the pedestrian or so.

Next, in Step S173, the number of pixels having values equal to or more than the predetermined luminance value BRCNT is set to BRCNT=0, and the process of Steps S174 and S175 is repetitively performed for every pixel of the image IMGSRC[x][y] within the light source determination region (SXL[j], SYL[j], EXL[j], EYL[j]) of interest.

In Step S174, it is determined whether or not the luminance value of the image IMGSRC[x][y] of the coordinates (x, y) is equal to or more than the predetermined luminance threshold value TH_cLIGHTBRIGHT#. If it is determined to be equal to or more than the threshold value, the process shifts to Step S175, and the number of the pixels having values equal to or more than the predetermined luminance value BRCNT is increment by one. If it is determined to be less than the threshold value, no increment operation is performed.

After the above described process is performed for every pixel in the light source determination region (SXL[j], SYL[j], EXL[j], EYL[j]), in Step S176, it is determined whether or not the number of the pixels having values equal to or more than the predetermined luminance value BRCNT is equal to or more than the predetermined area threshold value TH_cLIGHTAREA#, so as to determine whether the light source determination region is the pedestrian or the light source.

If the determination result is equal to or more than the threshold value, the process shifts to Step 177, and the pedestrian region (SXP[p], SYP[p], EXP[p], EYP[p]) and the pedestrian object information (relative distance PYF2[p], horizontal position PXF2[p], horizontal width WDF2[p]) are calculated, and the p is incremented. In Step S176, if the determination result is the light source, no process is performed.

The above described process is performed for every object in the first pedestrian determination region (SXJ1[j], SYJ1[j], EXJ1[j], EYJ1[j]) of interest, and the process is completed.

The luminance threshold value TH_cLIGHTBRIGHT# and the area threshold value TH_cLIGHTAREA# are determined in advance based on the data regarding the pedestrian detected at the pedestrian candidate setting unit 1031 and the first pedestrian determination unit 3041, and the data regarding the head light false detected at the pedestrian candidate setting unit 1031 and the first pedestrian determination unit 3041.

The area threshold value TH_cLIGHTAREA# may be determined based on the condition of the light source area.

As described above, the configuration of including the second pedestrian determination unit 3051 can eliminate the false detection for an artificial object such as a utility pole, a guardrail and road paintings as well as the false detection for a light source such as a headlight at the first pedestrian determination unit 3041. This configuration can cover many objects encountered on a public road likely to be false detected as the pedestrian if using the pattern matching, thereby contributing to reduction of the false detections.

The present embodiment is applied to the pedestrian detection system based on the visible image picked up by the visible camera, and may also be applicable to a pedestrian detection system based on an infrared image picked up by a near-infrared camera or a far-infrared camera other than the visible image.

The present invention is not limited to the above described embodiments, and may be variously modified without departing from the spirit and scope of the invention.

1. An environment recognizing device for a vehicle comprising:
an image acquisition unit for acquiring a picked up image in front of an own vehicle;
a processing region setting unit for setting a processing region used for detecting a pedestrian from the image;
a pedestrian candidate setting unit for setting a pedestrian candidate region used for determining an existence of the pedestrian from the image; and
a pedestrian determination unit for determining whether the pedestrian candidate region is the pedestrian or an artificial object depending on a gray-scale variation rate in a predetermined direction within the pedestrian candidate region.

2. The environment recognizing device for a vehicle according to claim 1, wherein
the pedestrian candidate setting unit extracts a pedestrian candidate region likely to be the pedestrian from the image within the processing region by using an identifier generated by off-line learning.

3. The environment recognizing device for a vehicle according to claim 1,
further comprising an object detection unit for acquiring object information regarding a detected object existing in front of the own vehicle,
wherein
the processing region setting unit sets the processing region in the image based on the acquired object information.

4. The environment recognizing device for a vehicle according to claim 1, wherein the artificial object includes any one of a utility pole, a guardrail and road paintings.

5. The environment recognizing device for a vehicle according to claim 1, wherein the pedestrian candidate setting unit:
extracts edges from the image so as to generate an edge image;
sets a matching determination region used for determining the pedestrian based on the edge image; and
sets the matching determination region to be the pedestrian candidate region if the matching determination region is determined to be the pedestrian.

6. The environment recognizing device for a vehicle according to claim 1, wherein the pedestrian determination unit:
calculates directional gray-scale variations in plural directions from the image;
calculates a gray-scale variation rate in a vertical direction and a gray-scale variation rate in a horizontal direction based on the calculated gray-scale variations from the pedestrian candidate region; and
determines the pedestrian candidate region to be the pedestrian if the calculated gray-scale variation rate in the vertical direction is less than a predefined threshold value for the vertical direction and if the calculated gray-scale variation rate in the horizontal direction is less than a predefined threshold value for the horizontal direction.

7. The environment recognizing device for a vehicle according to claim 1, wherein
the pedestrian candidate setting unit calculates pedestrian candidate object information from the pedestrian candidate region.

8. The environment recognizing device for a vehicle according to claim 7,
further comprising a first collision determination unit for determining whether or not there is a danger that the own vehicle will collide with a detected object based on the pedestrian candidate object information, and generates an alarm signal or a brake control signal based on a result of the determination.

9. The environment recognizing device for a vehicle according to claim 8, wherein the first collision determination unit:
acquires the pedestrian candidate object information;
calculates collision prediction time required for the own vehicle to collide with the object detected from the pedestrian candidate object information based on a relative distance and a relative speed between the detected object and the own vehicle;
calculates a degree of collision danger based on a distance between the object detected from the pedestrian candidate object information and the own vehicle; and
determines whether or not there is a danger of collision based on the collision prediction time and the degree of collision danger.

10. The environment recognizing device for a vehicle according to claim 9, wherein the first collision determination unit:
selects the object having a highest degree of collision danger; and
generates an alarm signal or a brake control signal if the collision prediction time relative to the selected object is equal to or less than a predefined threshold value.

11. The environment recognizing device for a vehicle according to claim 6,
further comprising a second collision determination unit for determining whether or not there is a danger that the own vehicle will collide with the pedestrian based on pedestrian information regarding the pedestrian determined at the pedestrian determination unit, and generates an alarm signal or a brake control signal based on a result of the determination.

12. The environment recognizing device for a vehicle according to claim 11, wherein the second collision determination unit:
acquires the pedestrian information;
calculates collision prediction time required for the own vehicle to collide with the pedestrian based on a relative distance and a relative speed between the pedestrian detected from the pedestrian information and the own vehicle;
calculates a degree of collision danger based on a distance between the pedestrian detected from the pedestrian information and the own vehicle; and
determines whether or not there is a danger of collision based on the collision prediction time and the degree of the collision danger.

13. The environment recognizing device for a vehicle according to claim 12, wherein the second collision determination unit:
selects the pedestrian having a highest degree of collision danger; and
generates an alarm signal or a brake control signal if the collision prediction time relative to the selected pedestrian is equal to or less than a predefined threshold value.

14. The environment recognizing device for a vehicle according to claim 1,
further comprising a pedestrian decision unit for deciding an existence of the pedestrian in a region determined to be the pedestrian at the pedestrian determination unit, by using an identifier generated by off-line learning.

15. The environment recognizing device for a vehicle according to claim 1, wherein
the pedestrian determination unit comprises a first pedestrian determination unit and a second pedestrian determination unit,
the first pedestrian determination unit determines whether the pedestrian candidate region is the pedestrian or the artificial object depending on a gray-scale variation rate in a predetermined direction within the pedestrian candidate region, and
the second pedestrian determination unit determines whether a pedestrian determination region determined to be the pedestrian at the first pedestrian determination unit is the pedestrian or the artificial object based on a number of pixels having values equal to or more than a predetermined luminance value in the pedestrian determination region.
